(19) United States
(12) Patent Application Publication
(10) Pub. No.: US 2022/0222440 A1
(43) Pub. Date: Jul. 14, 2022

(54) SYSTEMS AND METHODS FOR ASSESSING RISK ASSOCIATED WITH A MACHINE LEARNING MODEL

(71) Applicants: Rumman Chowdhury, San Francisco, CA (US); Xavier Magno Puspus, Taguig City (PH); Carlos Almendral, Quezon City (PH)

(72) Inventors: Rumman Chowdhury, San Francisco, CA (US); Xavier Magno Puspus, Taguig City (PH); Carlos Almendral, Quezon City (PH)

(21) Appl. No.: 17/575,700

(22) Filed: Jan. 14, 2022

Related U.S. Application Data
(60) Provisional application No. 63/137,675, filed on Jan. 14, 2021.

(51) Int. Cl. G06F 40/289; G06N 20/00

(52) U.S. Cl. CPC G06F 40/289; G06N 20/00

(57) ABSTRACT

Techniques for assessing risk associated with a machine learning model trained to perform a task. The techniques include: using at least one computer hardware processor to execute software to perform: obtaining natural language text including a plurality of answers to a respective plurality of questions for assessing risk for the machine learning model; identifying, using a second natural language processing (NLP) technique and from among a plurality of topics, the risk report indicating at least one risk associated with the machine learning model and at least one action to perform for mitigating the at least one risk associated with the machine learning model; and outputting the risk report to a user of the software.

### RELATED APPLICATIONS

This application claims the benefit under 35 U.S.C. § 119(e) of U.S. provisional patent application Ser. No. 63/137,675, entitled “SYSTEMS AND METHODS FOR ASSESSING RISK ASSOCIATED WITH A MACHINE LEARNING MODEL”, filed Jan. 14, 2021, Attorney Docket No. P1170.70000US00, which is herein incorporated by reference in its entirety.

### BACKGROUND

Natural language processing (NLP) is the processing of natural text data to extract information and insights. NLP techniques may be used to process natural language text for different NLP tasks, for example, to filter e-mail messages based on certain words or phrases, to produce relevant results for a search engine, to identify the main topics of a research article, or to give autocomplete suggestions based on the first few words of a text message.

### SUMMARY

Some embodiments provide for a method for assessing risk associated with a machine learning model trained to perform a task, the method comprising: using at least using at least one computer hardware processor to execute software to perform: obtaining natural language text comprising a plurality of answers to a respective plurality of questions for assessing risk for the machine learning model; identifying, using a second natural language processing (NLP) technique and from among a plurality of topics, a set of one or more topics related to risk associated with the machine learning model; generating a risk report for the machine learning model using the identified set of topics, the risk report indicating at least one risk associated with the machine learning model and at least one action to perform for mitigating the at least one risk associated with the machine learning model; and outputting the risk report to a user of the software.

Some embodiments provide for a system comprising: at least one computer hardware processor; and at least one non-transitory computer-readable storage medium storing processor executable instructions that, when executed by the at least one computer hardware processor, cause the at least one computer hardware processor to perform a method for assessing risk associated with a machine learning model trained to perform a task, the method comprising: obtaining natural language text comprising a plurality of answers to a respective plurality of questions for assessing risk for the machine learning model; determining, using a first natural language processing (NLP) technique, whether the plurality of answers are complete; identifying, using a second NLP technique and from among a plurality of topics, a set of one or more topics related to risk associated with the machine learning model; generating a risk report for the machine learning model using the identified set of topics, the risk report indicating at least one risk associated with the machine learning model and at least one action to perform for mitigating the at least one risk associated with the machine learning model; and outputting the risk report to a user.

Some embodiments provide for at least one non-transitory computer-readable storage medium storing processor executable instructions that, when executed by at least one computer hardware processor, cause the at least one computer hardware processor to perform a method for assessing risk associated with a machine learning model trained to perform a task, the method comprising: obtaining natural language text comprising a plurality of answers to a respective plurality of questions for assessing risk for the machine learning model; determining, using a first natural language processing (NLP) technique, whether the plurality of answers are complete; identifying, using a second NLP technique and from among a plurality of topics, a set of one or more topics related to risk associated with the machine learning model; generating a risk report for the machine learning model using the identified set of topics, the risk report indicating at least one risk associated with the machine learning model and at least one action to perform for mitigating the at least one risk associated with the machine learning model; and outputting the risk report to a user.

Some embodiments further comprise, after obtaining the natural language text, determining, using a first NLP technique, whether the plurality of answers are complete.

In some embodiments, obtaining natural language text comprises: determining the plurality of questions based on input from a first user of the software; and sending a notification to a second user of the software to answer at least some of the plurality of questions.

In some embodiments, determining the plurality of questions comprises: identifying an initial set of questions; receiving input from the first user, the input being indicative of at least one question selected by the first user from a library of additional questions; and updating the initial set of questions to include the at least one question.

Some embodiments further comprise, presenting, to the first user, a graphical user interface providing access to a searchable catalog of artificial intelligence policy documents, at least some of the artificial intelligence policy documents being associated with respective questions for assessing risk of a machine learning model; and receiving the input being indicative of the at least one question through the graphical user interface.

In some embodiments, the plurality of answers comprises a first answer to a first question in the plurality of questions, and determining whether the plurality of answers are complete comprises determining whether the first answer is complete at least in part by: extracting a number of keywords from the first answer using the first NLP technique; and determining whether the number of keywords exceeds a specified threshold.

In some embodiments, extracting the number of keywords from the first answer using the first NLP technique comprises extracting the number of keywords using a graph-based keyword extraction technique.

In some embodiments, extracting the number of keywords from the first answer comprises: generating a graph representing the first answer, the graph comprising nodes representing words in the first answer and edges representing co-occurrence of words that appear within a threshold distance in the first answer; and identifying the number of keywords by applying a ranking algorithm to the generated graph.

In some embodiments, determining whether the plurality of answers are complete comprises determining whether at least a preponderance of the plurality of answers is complete by using the first natural language processing technique.

In some embodiments, determining whether the plurality of answers are complete comprises determining whether each of the plurality of answers is complete by using the first NLP technique.

In some embodiments, identifying the set of one or more topics related to risk associated with the machine learning model comprises: embedding the plurality of answers into a latent space to obtain an embedding, the latent space comprising coordinates corresponding to the plurality of topics; determining similarity scores between the embedding and the coordinates corresponding to the plurality of topics; and identifying the set of one or more topics based on the similarity scores.

In some embodiments, embedding the plurality of answers into the latent space comprises: generating a graph representing the plurality of answers; identifying, using the graph, a plurality of keywords and associated saliency scores; and generating a vector representing the plurality of keywords and their associated saliency scores.

In some embodiments, the at least one action to mitigate the risk comprises a first action to be performed on at least one data set used to train the machine learning model.

Some embodiments further comprise accessing the at least one data set; and performing the first action on the at least one data set.

In some embodiments, performing the first action comprises processing the at least one data set to determine at least one bias metric, performing at least one bias mitigation, and/or executing one or more model performance explainability tools.

In some embodiments, performing the first action comprises processing the at least one data set to determine at least one bias metric, the at least one bias metric comprising a statistical parity difference metric, an equal opportunity difference metric, an average absolute odds difference metric, a disparate impact metric, and/or a Theil index metric.

In some embodiments, performing the first action comprises modifying the at least one dataset to obtain at least one modified data set and re-training the machine learning model using the at least one modified data set.

In some embodiments, generating a machine learning model report, the machine learning model report comprising information indicating one or more actions, including the first action, taken to mitigate the at least one risk identified in the risk report; and outputting the machine learning model report to the user of the software.

### BRIEF DESCRIPTION OF DRAWINGS

Various aspects and embodiments of the disclosure provided herein are described below with reference to the following figures. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a diagram of an illustrative environment 100 in which some embodiments of the technology described herein may operate.

FIG. 1B is a diagram of example components of an illustrative application executing on the system of FIG. 1A, in accordance with some embodiments of the technology described herein.

FIG. 2A shows an example of a graphical user interface (GUI) for navigating the application of FIG. 1B, in accordance with some embodiments described herein.

FIG. 2B shows an example of a GUI for a searchable catalog of documents, in accordance with some embodiments of the technology described herein.

FIG. 2C shows an example of a GUI for selecting additional questions that are associated with a document in the searchable catalog of FIG. 2B, in accordance with some embodiments of the technology described herein.

FIG. 2D shows an example of a GUI for answering an initial set of questions for assessing risk, in accordance with some embodiments of the technology described herein.

FIG. 2E shows an example of a GUI for answering additional questions for assessing risk, in accordance with some embodiments of the technology described herein.

FIG. 2F shows an example risk report generated and output during process 300 illustrated in FIG. 3A, in accordance with some embodiments of the technology described herein.

FIG. 2G shows an example portion of a machine learning model report displaying descriptive statistics for a dataset, in accordance with some embodiments of the technology described herein.

FIG. 2H shows an example portion of a machine learning model report displaying protected attributes, in accordance with some embodiments of the technology described herein.

FIG. 2I shows an example portion of a machine learning model report displaying a business impact report, in accordance with some embodiments of the technology described herein.

FIG. 2J shows an example portion of a machine learning model report displaying unmitigated versus mitigated bias metric results, in accordance with some embodiments of the technology described herein.

FIG. 3A is a flowchart of an illustrative process 300 for assessing risk associated with a machine learning model trained to perform a task, in accordance with some embodiments of the technology described herein.

FIG. 3B is a flowchart illustrating an example implementation of act 304 of process 300 for determining whether an answer is complete, in accordance with some embodiments of the technology described herein.

FIG. 3C is a flowchart illustrating an example implementation of act 306 of process 300 for identifying the set of one or more topics related to risk associated with the machine learning model, in accordance with some embodiments of the technology described herein.

FIG. 4 shows an example list of questions for assessing risk and respective example answers, in accordance with some embodiments of the technology described herein.

FIG. 5 is an example flowchart of process 500 for determining whether an answer is complete, in accordance with some embodiments of the technology described herein.

FIGS. 6A-B shows an example of a complete answer being checked for completeness, in accordance with some embodiments of the technology described herein.

FIGS. 6C-D shows an example of an incomplete answer being checked for completeness, in accordance with some embodiments of the technology described herein.

FIG. 7A shows an example of coordinates corresponding to topics related to risk, in accordance with some embodiments of the technology described herein.

FIG. 7B shows an example of results that may be obtained at act 306 of process 300 for processing answers that are constructed such that they can be described by a combination of the topics related to risk, in accordance with some embodiments of the technology described herein.

FIG. 7C shows an example of results that may be obtained at act 306 of process 300 for processing answers that are constructed such that no keywords are extracted, in accordance with some embodiments of the technology described herein.

FIG. 8 depicts an illustrative implementation of a computer system that may be used in connection with some embodiments of the technology described herein.

### DETAILED DESCRIPTION

Developments in artificial intelligence (AI) have made it possible to analyze and draw meaningful insights from large volumes of data. Specifically, machine learning, a branch of AI, involves computers learning from data to complete a specific task. As such, machine learning techniques have been applied in a wide range of industries to increase task efficiency and inform decisions.

The application of AI and machine learning in business can help to increase sales through personalized marketing, improve customer experience by suggesting relevant products, and help to manage inventory and delivery. Further, machine learning models can be employed to help inform important decisions or predict future business developments, which may then inform changes to an existing business strategy. As a first example, an employee attrition machine learning model may be used to help companies to determine the likelihood that an employee will quit in the near future. The model may be trained using data corresponding to past and current employees to derive insights related to attrition that can be used to design effective interventions. As a second example, employers may use a hiring machine learning model to help identify ideal candidates for a position. The model may analyze data corresponding to each candidate, such as age, gender, location, and education, to help a hiring manager prioritize applications.

To avoid unintended outcomes that may lead to ethical and/or legal consequences for a business, it is important that a machine learning model and/or data used to train a machine learning model addresses potential biases that result from flawed data or assumptions built into the machine learning model. For example, in the case of the employee attrition machine learning model, there may be legally mandated protected classes that need to be addressed during model development and training. If the model is trained on a poorly sourced data set, it may incorrectly predict that employees of a particular race, gender, or age are more likely to quit. This may expose an organization using such a machine learning model to legal consequences and reputational harm. As another example, a hiring machine learning model may be trained to identify ideal candidates based on their proximity to a job location. Given a job location in a wealthy area, this model may be biased against candidates in a lower economic class. Again, gone unchecked, this model may lead to biased outcomes, legal consequences, and reputational harm. The inventors have appreciated that identifying and addressing risk associated with machine learning models is important.

The inventors have recognized that conventional methods for identifying risk associated with a machine learning model and the appropriate tools to mitigate those risks have drawbacks that may be improved upon. Such conventional methods typically involve: (1) identifying a type of risk to address; and (2) completing tasks to mitigate that risk.

One problem with such conventional techniques has to do with the manner in which the type of risk is selected. Given large volumes of data and numerous types of risk that could be associated with the model and/or data (e.g., risk associated with data processing, data modelling, data transparency, etc.), it is not always possible to identify the most relevant or important types of risk to address. Further, there may be certain data compliance regulations, internal business goals, employment laws, and other external factors that may complicate this process. As a result, less obvious types of risk may be left unaddressed, leading to unintentional and potentially damaging consequences.

Another problem with conventional techniques is that, once a type of risk has been selected, the tools used to mitigate that risk do not always meet the goals of the model. While there are many known metrics and mitigation tools that may be used to address different types of risk, the tools may depend on certain thresholds or parameters to be established that depend upon the goals and standards of each model and business. However, conventional techniques for addressing risk do not account for all of these factors. Typically, the data scientists who utilize the tools depends upon general guidelines or standards to inform thresholds and parameters, which may lead to missed, company-specific needs. For example, the 80% rule is oftentimes used to determine whether a model and/or data is biased. The 80% rule is a suggestion that companies should hire protected groups at a rate that is at least 80% of that of majority groups. Oftentimes, risk mitigation is deemed to be complete if this rule is met. While this is one tool for ensuring that the data is not biased towards specific, legally defined groups, it does not factor in other parameters that may be important to the model and less obvious to the person analyzing the data. For example, the model may contain bias against groups that are not protected by law, such as women who experienced a major life event (e.g., giving birth, marriage), which would not be addressed by this application of the 80% rule.

A third problem is that conventional risk assessment techniques assume the assessor is aware of the full spectrum of possible risky outcomes. Given the dynamic nature of machine learning output, this is not necessarily the case. While experience and subject matter expertise can help with risk identification, the complexity of risks introduced by the use of AI or machine learning models can make it difficult to pre-emptively identify all risks and link them to the appropriate data science interventions. Increasingly, risk assessors of AI or machine learning models employ impact assessments, a series of risk-related questions. However, translating these text-based assessments to actionable data and model based intervention can be difficult.

The inventors have developed techniques for more accurately assessing risk associated with a machine learning model that address the above-described problems of conventional techniques. The inventors have developed techniques for identifying topics related to risk associated with the machine learning model. In some embodiments, the techniques include receiving answers to questions associated with risk from one or more users (e.g., risk and compliance teams, managers, etc.) that address the goals of the model, important compliance issues, and details about the data. The techniques may include determining topics related to risk using the answers and one or more NLP techniques, as described herein. Once the set of topics has been identified, the techniques may include indicating a suggested action to perform to mitigate the identified risk.

In some embodiments, NLP techniques used for determining topics related to risk may include using a machine learning model (e.g., graph-based model, a neural network model, a Bayesian model, or any other suitable type of machine learning model) trained to identify one or more topics associates with input text. Training the machine learning model may comprise estimating values for parameters of the machine learning model from training data. In some embodiments, the machine learning model may include thousands, tens of thousands, hundreds of thousands, at least one million, millions, tens of millions, or hundreds of millions of parameters. In some embodiments, the training data used to estimate values of the model parameters includes a corpus of text having at least 1,000, at least 10,000, at least 100,000, or at least 1 million documents. In some implementations, a machine learning model may have parameters for multiple keywords (at least 1000 keywords, at least 10,000 keywords, at least 100,000 keywords, at least one million keyworks, etc.) for each topic and training the machine learning model may include estimating values of these parameters, computationally from a corpus of documents as part of the training data.

The techniques described herein and developed by the inventors offer a significant improvement in performance, accuracy, and efficiency over conventional methods for assessing risk associated with a machine learning model in an automated, principled, and computational way by using natural language processing techniques. As a result, the techniques described herein constitute an improvement to machine learning technology generally and, specifically, to the technology for computational removal of bias from machine learning models because the techniques described herein provide for improved methods of detecting bias and/or risk associated with a machine learning model and mitigating that risk, for example, through changing the structure of the model and/or augmenting or otherwise modifying the training data.

Accordingly, some embodiments provide for computer-implemented techniques to assess risk associated with a machine learning model trained to perform a task (e.g., an employee attrition model). In some embodiments, the techniques include: (A) obtaining natural language text (e.g., through a GUI) including a plurality of answers to a respective plurality of questions (e.g., standard and custom questions) for assessing risk for the machine learning model; (B) identifying, using a second natural language processing (NLP) technique (e.g., graph-based model, neural networks, etc.) and from among a plurality of topics (e.g., data modelling, data transparency, data protection, etc.), a set of one or more topics related to risk associated with the machine learning model; (C) generating a risk report for the machine learning model and at least one action (e.g., reweighing, prejudice remover, review data collection procedures, etc.) to perform for mitigating the at least one risk associated with the machine learning model; and (D) outputting the risk report to a user of the software.

Some embodiments further include, after obtaining the natural language text, determining, using a first NLP technique (e.g., graph-based model, word count, deep learning, etc.), whether the plurality of answers are complete (e.g., include a sufficient number of keywords).

In some embodiments, obtaining the natural language text includes: determining the plurality of questions based on input (e.g., free-form text input or user selection from a searchable catalog) from a first user of the software; and sending a notification (e.g., SMS, e-mail, instant messaging, etc.) to a second user (e.g., one or more users) of the software to answer at least some of the plurality of questions.

In some embodiments, determining the plurality of questions includes: identifying an initial set of questions (e.g., standard questions included in software or questions written by user); receiving input from the first user, the input being indicative of at least one question selected by the first user from a library of additional questions (e.g., extracted and/or generated from existing documents); and updating the initial set of questions to include the at least one question.

Some embodiments further include: presenting to a first user, a graphical user interface providing access to a searchable catalog of artificial intelligence documents (e.g., General Data Protection Regulation (GDPR) documents), at least some of the artificial intelligence policy documents being associated with respective questions for assessing risk of a machine learning model; and receiving input (e.g., user submits a list of selected questions) being indicative of the at least one question through the graphical user interface.

In some embodiments, the plurality of answers includes a first answer to a first question in the plurality of questions, and determining whether the plurality of answers are complete includes determining whether the first answer is complete at least in part by: extracting a number of keywords (e.g., set of terms included in the text) from the first answer using the first NLP technique; and determining whether the number of keywords exceeds a specified threshold (e.g., more than 1, 2, 3, 4, 5, or 6 keywords).

In some embodiments, extracting the number of keywords from the first answer using the first NLP technique includes extracting the number of keywords using a graph-based keyword extraction technique (e.g., TextRank).

In some embodiments, extracting the number of keywords from the first answer includes: generating a graph representing the first answer, the graph comprising nodes representing words in the first answer and edges representing co-occurrence of words that appear within a threshold distance (e.g., co-occurrence window of 1, 2, 3, or 4) in the first answer; and identifying the number of keywords by applying a ranking algorithm (e.g., TextRank) to the generated graph.

In some embodiments, determining whether the plurality of answers are complete includes determining whether at least a preponderance of the plurality of answers is complete by using the first natural language processing technique.

In some embodiments, determining whether the plurality of answers are complete includes determining whether each of the plurality of answers is complete by using the first NLP technique.

In some embodiments, identifying the set of one or more topics related to risk associated with the machine learning model includes: embedding the plurality of answers into a latent space to obtain an embedding, the latent space including coordinates (e.g., basis vectors) corresponding to the plurality of topics; determining similarity scores (e.g., cosine similarity) between the embedding and the coordinates corresponding to the plurality of topics; and identifying the set of one or more topics based on the similarity scores.

In some embodiments, embedding the plurality of answers into the latent space includes: generating a graph representing the plurality of answers; identifying, using the graph, a plurality of keywords and associated saliency score; and generating a vector representing the plurality of keywords and their associated saliency scores.

In some embodiments, the at least one action to mitigate the risk includes a first action (e.g., reweighing) to be performed on at least one data set used to train the machine learning model.

Some embodiments further include accessing the at least one data set (e.g., data used to train the model); and performing the first action on the at least one data set.

In some embodiments, performing the first action includes processing the at least one data set to determine at least one bias metric (e.g., equal opportunity difference, statistical parity difference, average absolute odds difference, disparate impact, Theil index, etc.), performing at least one bias mitigation (e.g., disparate impact remover, learning fair representation, reweighing, prejudice remover, calibrated equality of odds, etc.), and/or executing one or more model performance explainability tools (e.g., counterfactuals, Shapley Additive Explanations (SHAP), etc.).

In some embodiments, performing the first action includes processing the at least one set to determine at least one bias metric, the at least one bias metric including a statistical parity difference metric, an equal opportunity difference metric, an average absolute odds difference metric, a disparate impact metric, and/or a Theil index metric.

In some embodiments, performing the first action includes modifying the at least one dataset to obtain at least one modified data set and re-training the machine learning model using the at least one modified data set.

Some embodiments further include generating a machine learning model report, the machine learning model report including information indicating one or more actions, including the first action, taken to mitigate the at least one risk identified in the risk report; and outputting the machine learning model to the user of the software (e.g., through a GUI).

It should be appreciated that the techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

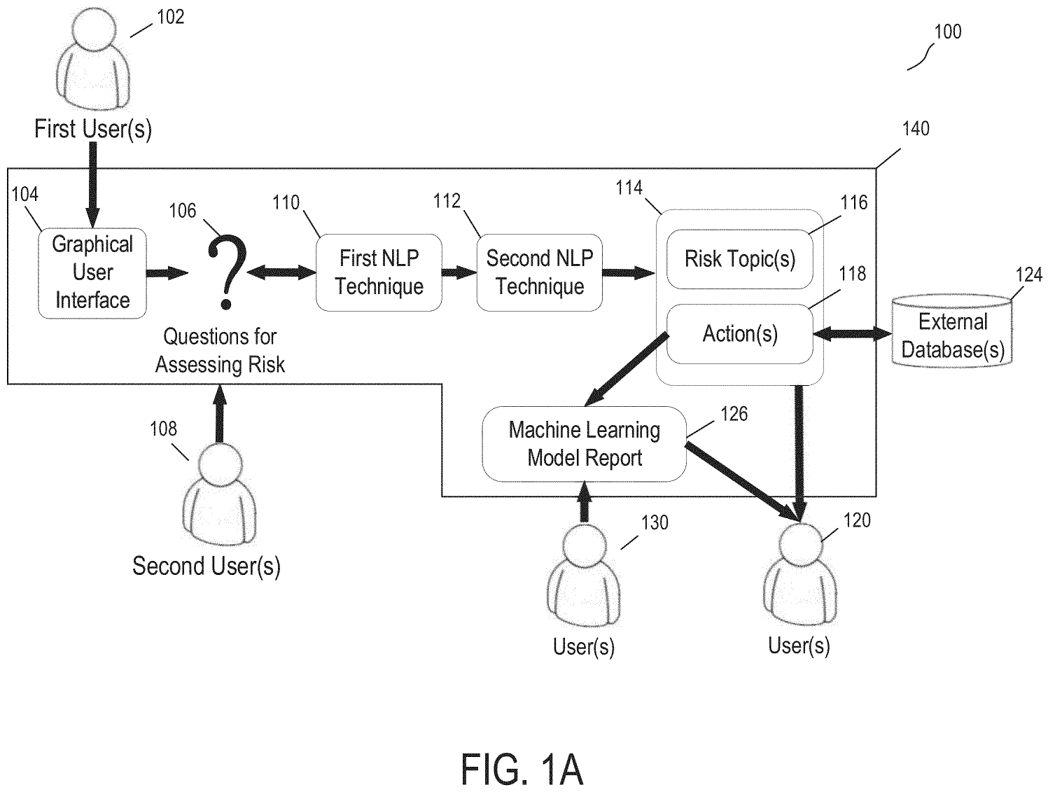

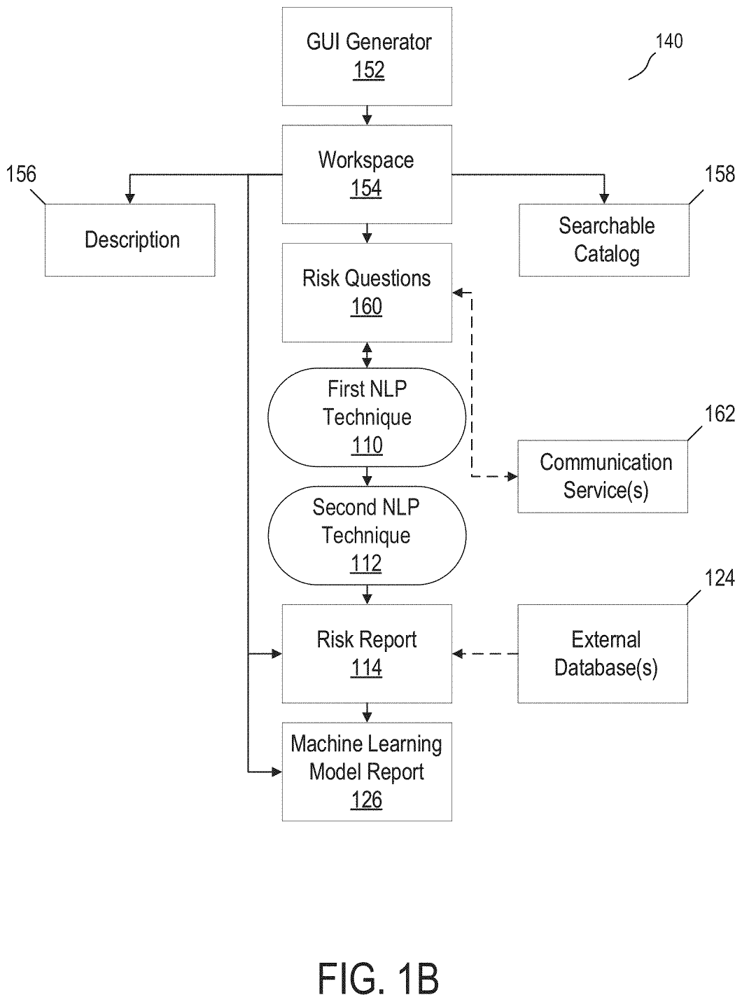

FIG. 1A is a diagram of an illustrative technique 100 for assessing risk associated with a machine learning model trained to perform a task. The technique 100 may be conducted in an environment that includes system 140 that may be configured by first user(s) 102 to perform an NLP task and generate one or more reports. As part of the configuration, first user(s) 102 may interact with graphical user interface (GUI) 104 to input information related to datasets used to train the model (e.g., number of variables, number and percent of missing variables, size of database, etc.), add and answer questions for assessing risk 106, assign questions for assessing risk to second user(s) 108, and/or change the structure of one or more documents within system 140. Second user(s) 108 may also add and/or answer questions for assessing risk 106 through GUI 104 or any other suitable user interface.

In some embodiments, answers to questions for assessing risk 106 may be used as input to a first NLP technique 110 for checking the answers for completeness. Based on the result of the first NLP technique 110, first and second user(s) 102, 108 may further contribute answers to the questions for assessing risk 106. Otherwise, the answers to the questions for assessing risk 106 may be used as input to a second NLP technique 112 for identifying a set of one or more topics related to risk associated with the machine learning model.

As a result of second NLP technique 112, risk report 114 may be generated and output to user(s) 120. In some embodiments, risk report 114 may indicate risk(s) 116 associated with the machine learning model and/or suggest action(s) 118 for measuring risk, mitigating risk, and/or explaining the output of second NLP technique 112. Risk report 114 may be output through GUI 104 or to any other suitable user interface or in any other suitable format (e.g., printed). In some embodiments, user(s) 120 may be the same as first user(s) 102, second user(s) 108, and/or user(s) 130.

In some embodiments, action(s) 118 may be linked to external databases(s) 124 that may include tools for completing the action(s) 118. User(s) 130 may use tools from external database(s) 124 that are suggested in the action(s) 118 to mitigate risk associated with the machine learning model. User(s) 130 may indicate the action(s) 118 that were taken and/or provide updated information about datasets to system 140. As a result, machine learning model report 126 may be generated and output to user(s) 120. In some embodiments, the machine learning model report 126 may be indicative of the questions for assessing risk 106 and/or the action(s) 118 that were taken to mitigate the risk. In some embodiments, the machine learning model report 126 may provide text and/or visuals.

As a non-limiting example of technique 100, a hiring manager may have developed a hiring machine learning model to identify potential candidates for an available position. The hiring manager may use technique 100 to identify potential risk associated with the model. She may interact with a GUI to configure a page that identifies the goals of the risk assessment, describes the hiring model, and indicates statistics related to the data used to train the model. In addition to the hiring manager, the risk and compliance teams may help to add and answer questions about the machine learning model. Their input may provide insight into important regulations or guidelines that the hiring manager could not provide. The hiring manager may also assign business-related questions to an executive of the company, who may answer the questions via a messaging platform which may automatically populate the questionnaire including the risk questions. Once all the questions have been answered, the hiring manager and/or members of the risk and compliance team may submit the questionnaire and then correct any answers that were deemed incomplete by the first NLP technique. After a final submission to the second NLP technique, a risk report may be generated, which may indicate any risks associated with the hiring model and suggested actions to mitigate that risk. Data scientists may perform the suggested actions, informed by further input from the risk and compliance team, who may describe important compliance parameters using a freeform text input. The data scientist may then indicate any risk mitigation actions that they took and input updated dataset information, which may inform the generation of the machine learning model report.

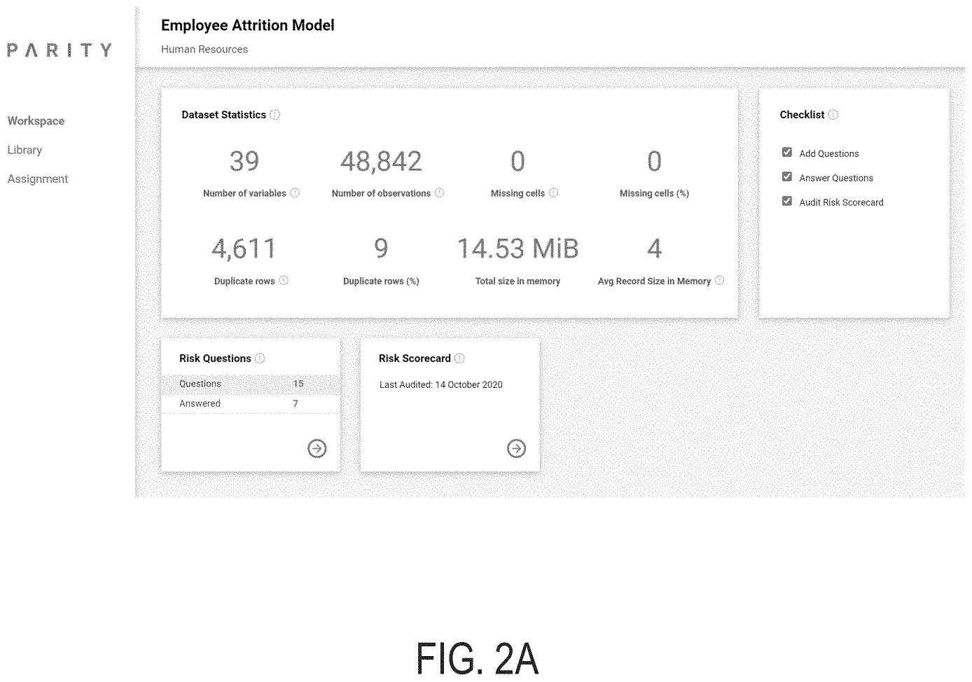

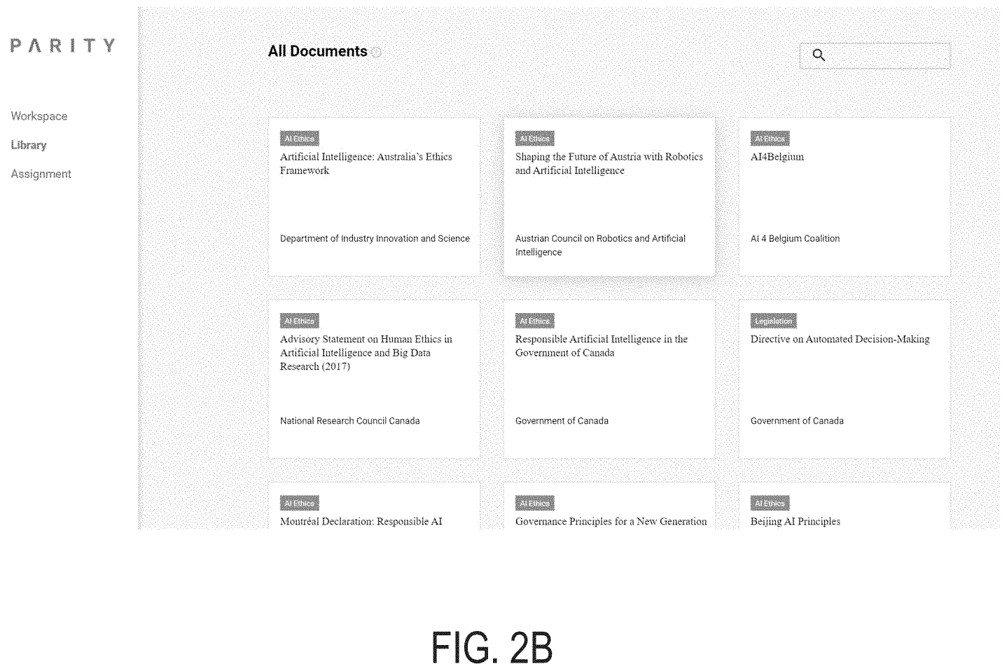

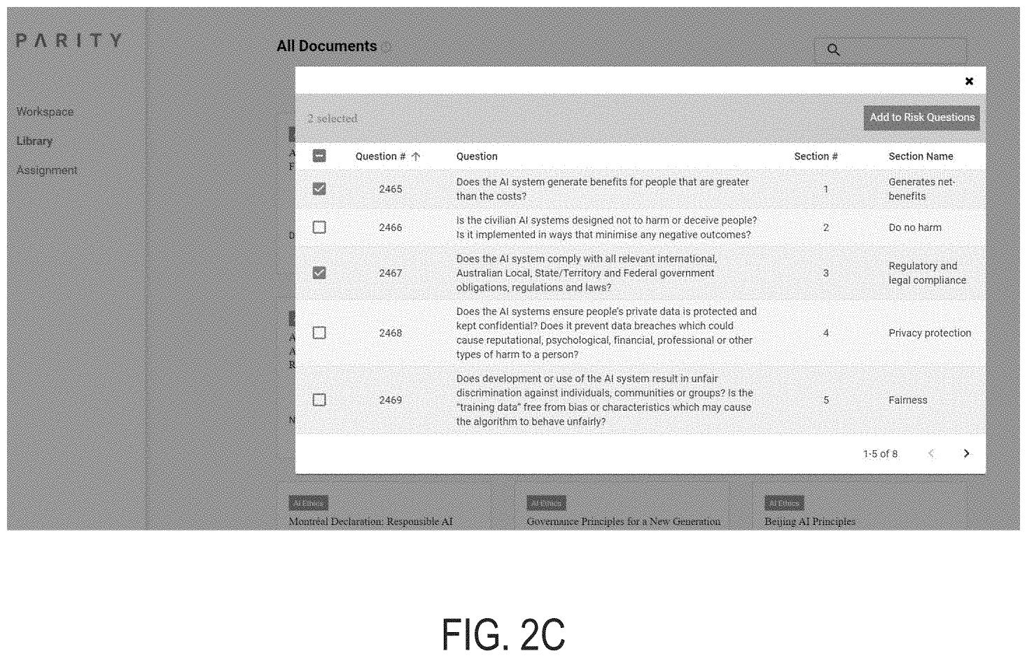

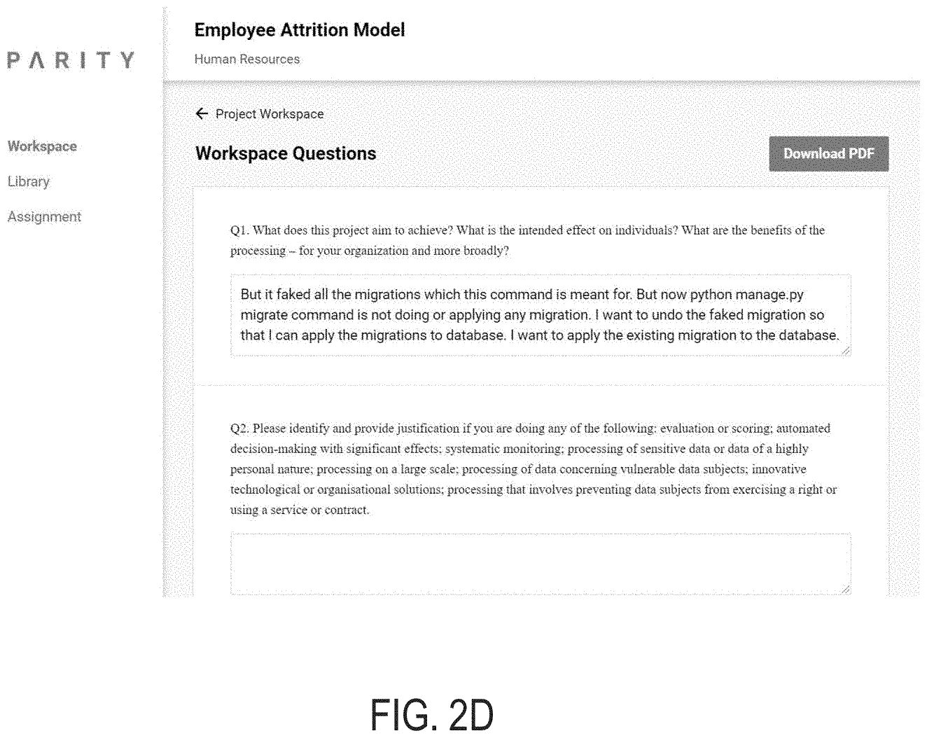

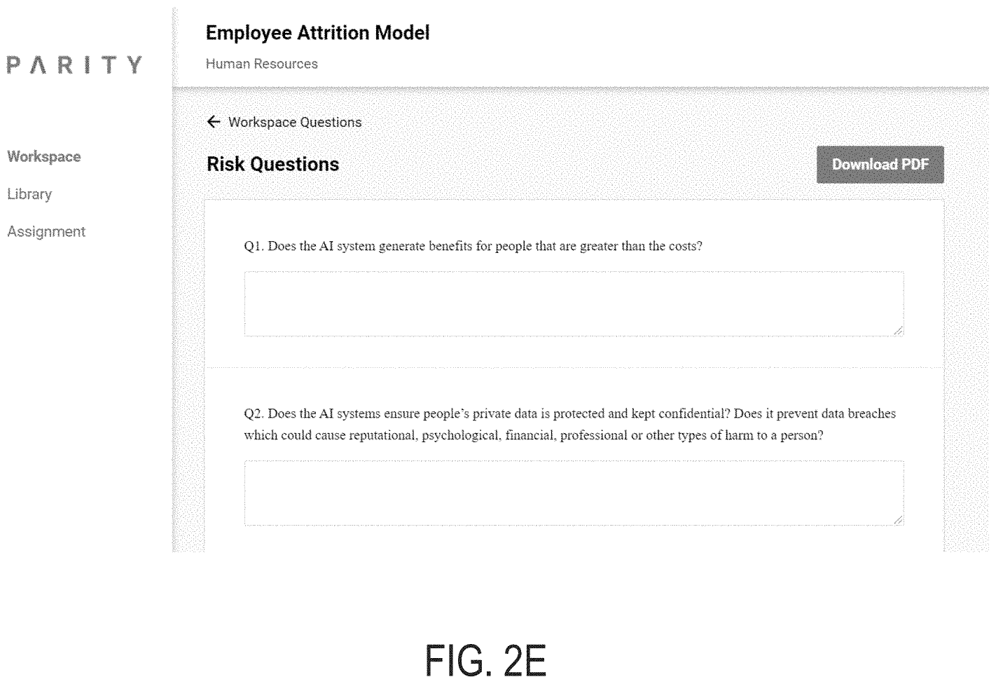

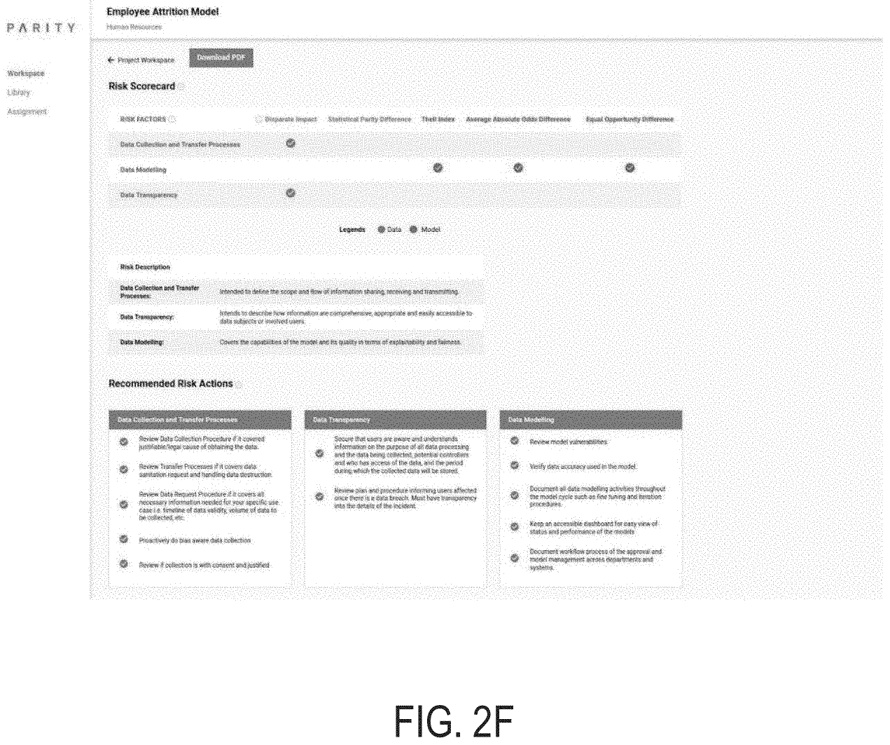

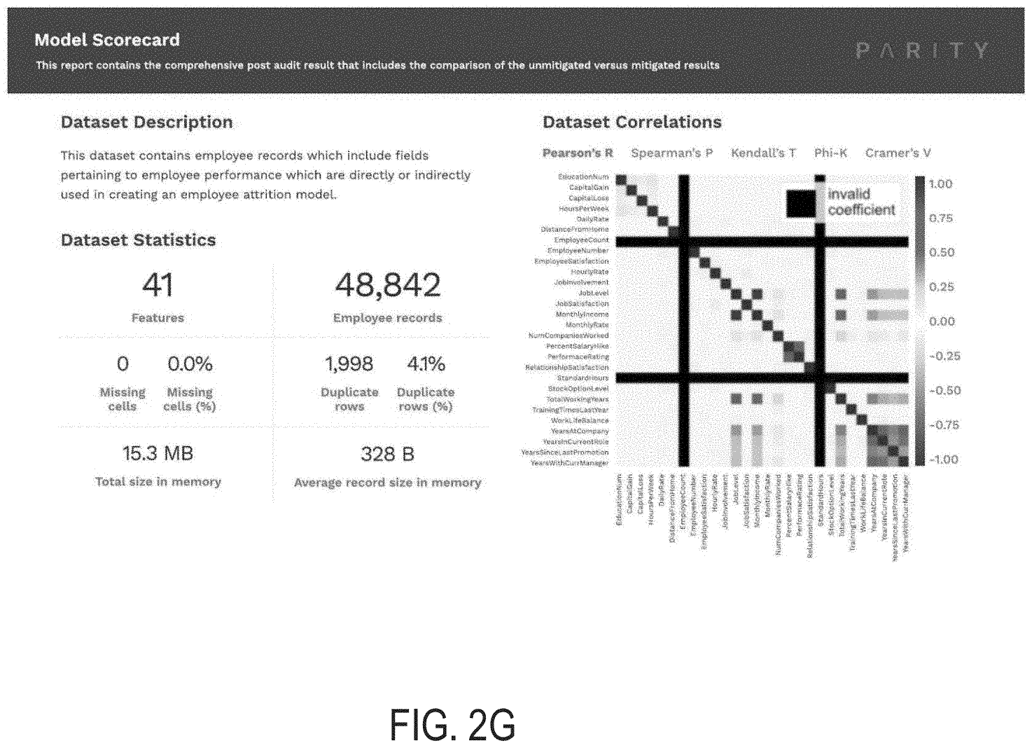

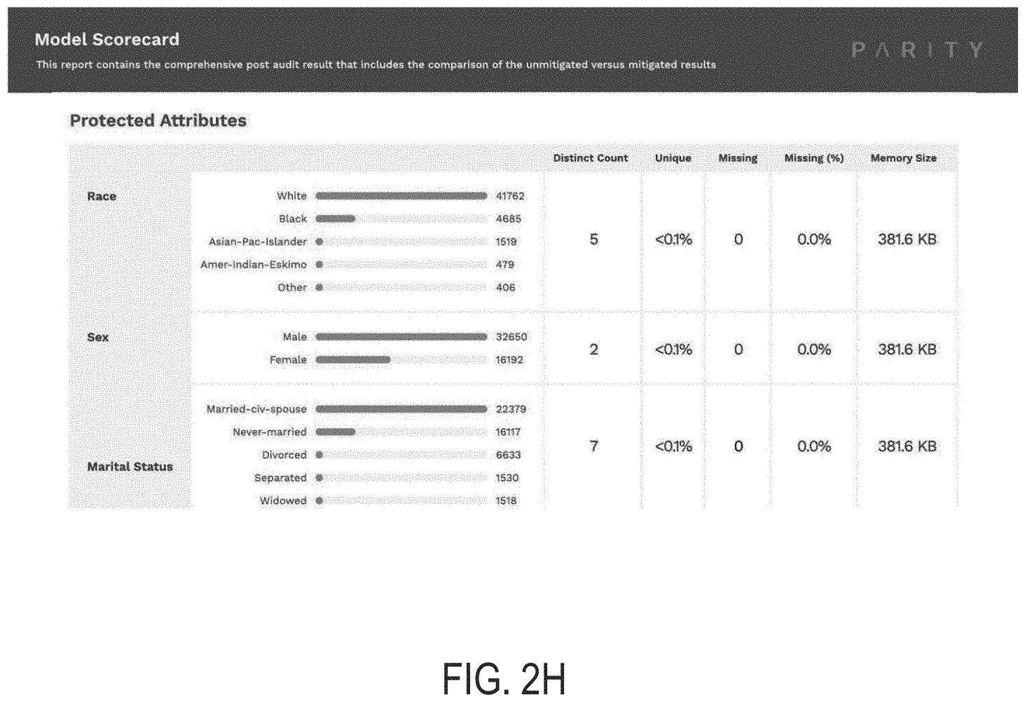

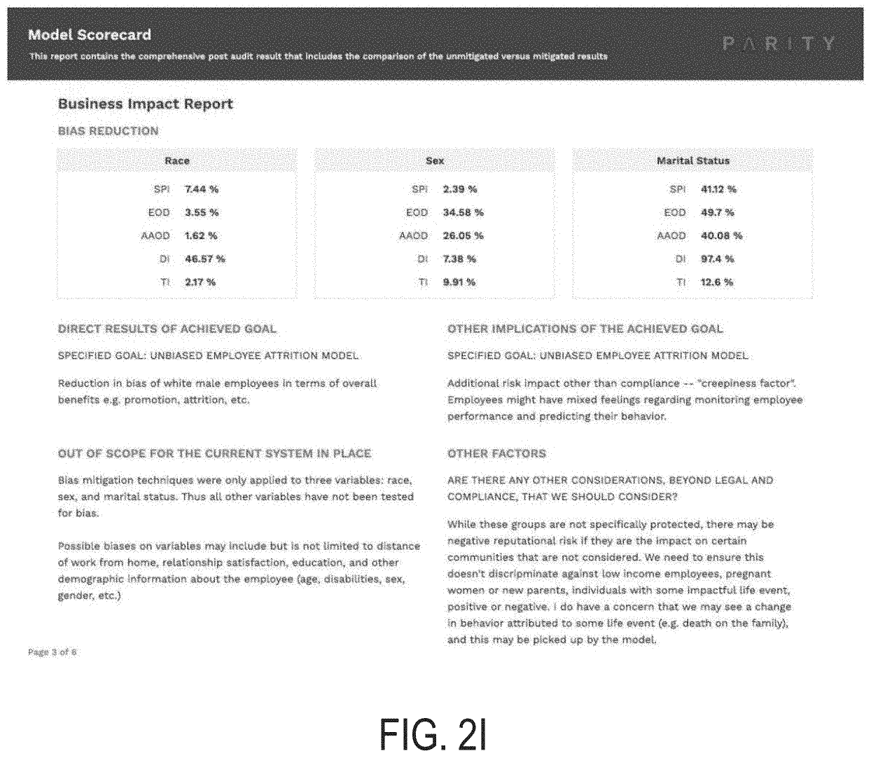

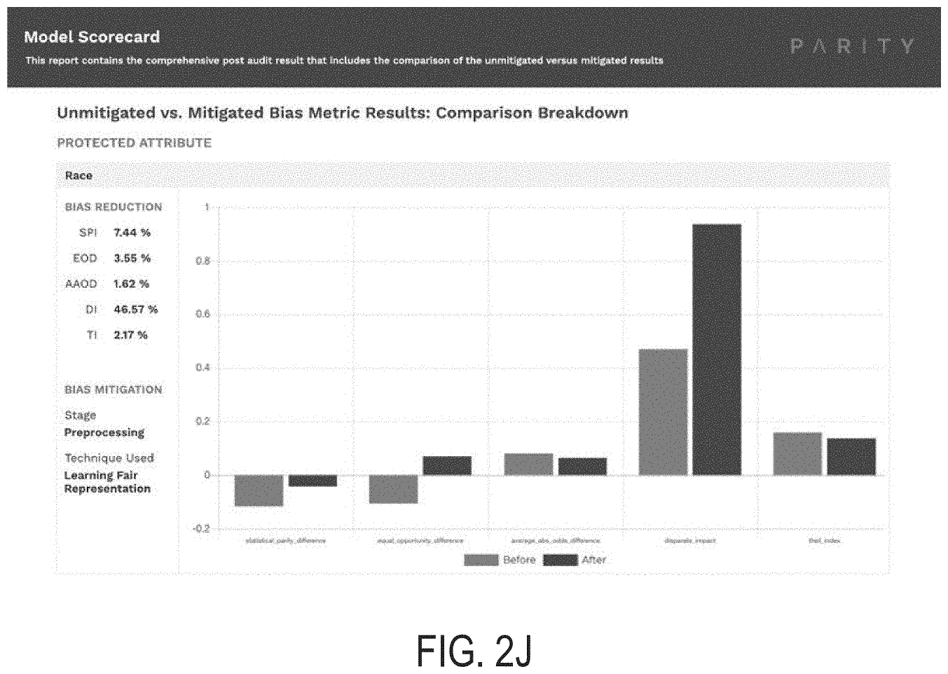

FIG. 1B is a diagram of example components of an illustrative application executing on the system of FIG. 1A, in accordance with some embodiments of the technology described herein. GUI generator 152 may be used to generate GUI 104, which may include one or more portions or pages. A first portion of GUI 104 may include Workspace 154. A user may interact with Workspace 154 to view an overview of some information or access other portions or pages of GUI 104. An example of Workspace 154 is described herein with respect to FIG. 2A.

Description 156 may be configured by first user(s) 102 to provide details about the machine learning model, details about the datasets, instructions for other users contributing to the risk assessment, and/or anything else first user(s) 102 may want to convey to other users (e.g., second user(s) 108, user(s) 120, user(s) 130).

Searchable Catalog 158 may be accessed by first and/or second user(s) 102, 108 for adding questions to the questions for assessing risk 106. In some embodiments, a user may peruse documents provided in the Searchable Catalog 158. Each document may be associated with relevant questions, and first and/or second user(s) 102, 108 may have the option to add one or more of those questions to the questions for assessing risk 106. An example of the Searchable Catalog is described herein with respect to FIGS. 2B-C.

Once all questions have been added to the questions for assessing risk 106, first and/or second user(s) 102, 108 may answer those questions within a Risk Questions 160 page of GUI 104. In some embodiments, Risk Questions 160 may include one or more pages listing an initial set of questions and/or one or more pages listing the questions added from the Searchable Catalog 158. In some embodiments, Risk Questions 160, and/or other pages of the GUI 104, may also be configured to allow users (e.g., first user(s) 102, second user(s) 108), and/or other users accessing the GUI 104) to add custom questions to the questions for assessing risk 106. First and/or second user(s) 102, 108 may then input answers to one or more text boxes within the Risk Questions 160 page of the GUI. Alternatively, communication service(s) 162 may enable first user(s) 102 to assign questions to second user(s) 108 through any suitable platform. In some embodiments, first and/or second user(s) 102, 108 may provide answers to questions for assessing risk 106 through communication service(s) 162, which may populate the Risk Questions 160 page. An example of Risk Questions 160 is described herein with respect to FIGS. 2E-D.

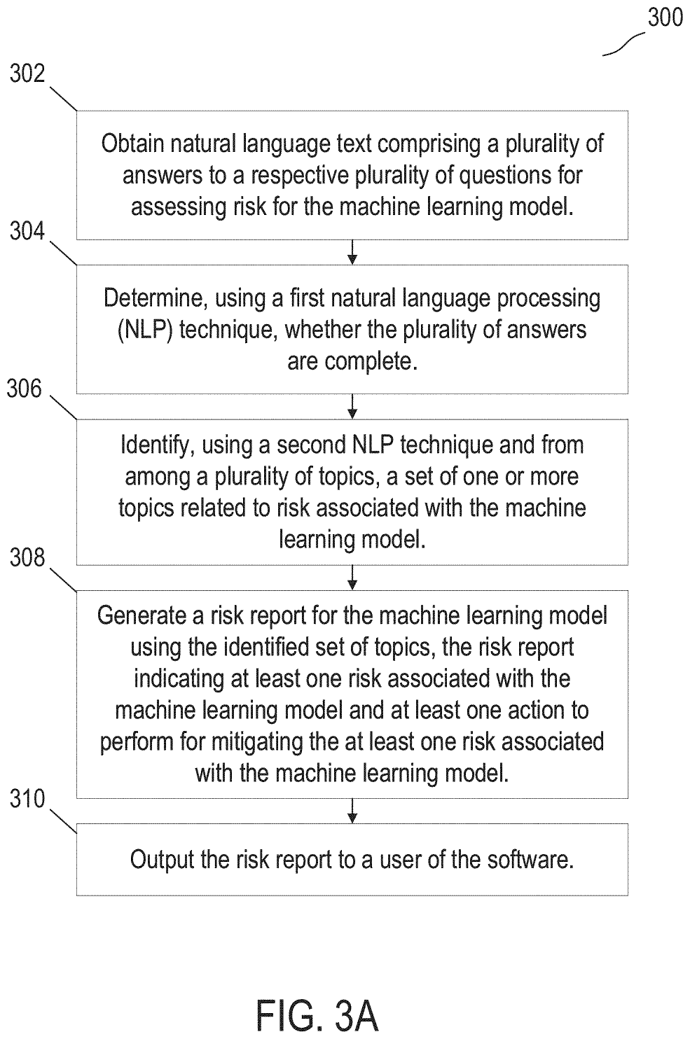

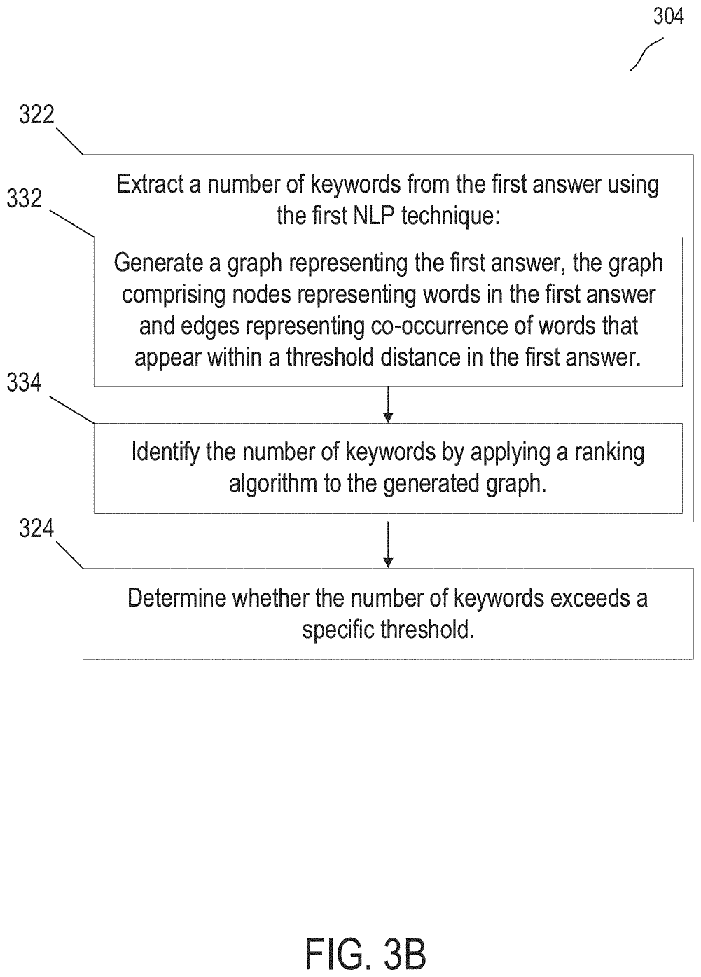

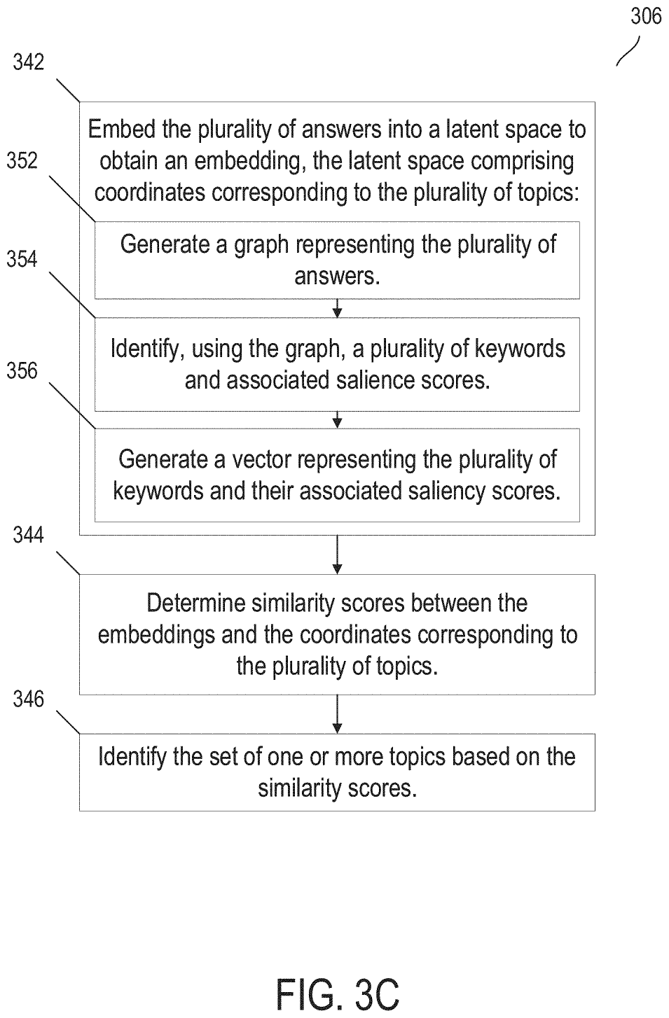

In some embodiments, once the questions for assessing risk 106 have been answered, they may be submitted to the first NLP technique 110 to check the answers for completeness. If deemed incomplete, the answers may be reviewed by first and/or second user(s) 102, 108 in Risk Question(s) 160 and resubmitted. If the answers are deemed complete, they may be submitted to the second NLP technique 112 to identify one or more topics related to risk. First and second NLP techniques 110, 112 are further described herein with respect to FIGS. 3A-C.

Once first and second NLP techniques 110, 112 have been completed, Risk Report 114 may be generated and accessed as a page in GUI 104. Risk Report 114 may be generated in part by identifying topics related to risk using the second NLP technique 112 and/or by accessing external database(s) 124, which may include suggested action(s) 118 and/or tools to complete action(s) 118 that are associated with topics associated with risk(s) 116 output by the second NLP model 112. Tables 2 and 3 respectively list examples of non-technical and technical actions that may be output in a risk report. An example of Risk Report 114 is described herein with respect to FIG. 2F.

Machine Learning Model Report 126 may be available as a page of GUI 104 as a result of one or more action(s) 118 being completed and/or updated dataset information being provided to the system 140. In some embodiments, Machine Learning Model Report 126 may include one or more pages and provide information regarding the action(s) 118, original and/or updated datasets, the machine learning model, and/or the risk assessment. An example of Machine Learning Model Report 126 is described herein with respect to FIGS. 2G-J.

FIGS. 2A-J show pages of an example GUI, some of which may have been described above with respect to FIG. 1B.

An example of Workspace 154, shown in FIG. 2A, includes a portion for displaying statistics related to a dataset that may have been provided by a user. It also includes a checklist, which may allow a user to visualize tasks that have been completed and tasks that need to be completed. The example workspace also includes navigational features (e.g., sidebar menu and arrows), allowing a user to navigate through pages of the GUI.

Using the sidebar menu, a user may navigate to the “Library,” which is an example of Searchable Catalog 158 shown in FIGS. 2B-C. As shown in FIG. 2B, the example GUI displays documents that the user may select. Some of the example documents include AI ethical codes, regulations, and guidelines in various countries. The user may use the search bar to search for particular documents that may be relevant to their risk assessment. The user may select a document, which opens a separate window, shown in FIG. 2C. The window displays a list of questions and indicates the section of the document that each question is associated with. The user may interact with the window to select questions by checking the boxes. Once the user is satisfied with the selected questions, the user may add the questions to the questions for assessing risk by selecting the button labelled “Add to Risk Questions.” Using the sidebar menu, the user may navigate to the workspace, and then use the arrows to navigate to the “Risk Questions,” which is an example of Risk Questions 160 shown in FIGS. 2D-E. As shown in FIG. 2D, a user may answer an initial set of questions in the spaces designated to input free form text. The example GUI also provides an option to download the questions and answers. The user may then navigate to a separate page, as shown in FIG. 2E, to answer questions that were added by the user in the Searchable Catalog 158.

Once the answers are submitted, a risk report may be generated. An example of Risk Report 114 is shown in FIG. 2F. As shown, the example risk report includes details of risks identified for the machine learning model and suggested actions to measure and mitigate the risk. A first portion of the GUI includes a table that maps each identified risk to suggested metrics for measuring the risk. The table further specifies whether the risk is associated with the data or with the machine learning model. A second portion of the GUI includes a description of each type of risk that was identified. A third portion of the GUI lists, for each type of risk, recommended actions for mitigating the risk. As described with respect to FIGS. 1A-B, the risk report may be generated, in part, by accessing an external database associating types of risks to actions.

The user may indicate which of the actions were performed and provide any additional information. As a result, a Machine Learning Model Report 126 may be generated. Machine Learning Model Report 126 may combine quantitative and qualitative information from the risk assessment. An example of Machine Learning Model Report 126 is shown in FIGS. 2G-J. The portion of the example machine learning model report shown in FIG. 2G includes a description of the dataset, dataset statistics, and correlations in the dataset. FIG. 2H is an example portion of a machine learning model report that displays the datasets in terms of protected attributes. This portion may visually highlight an action that a user took to understand how gender, race, and marital status are represented in the dataset. FIG. 2I is an example portion of the machine learning model report that may display a summary of the risk assessment, including bias mitigation, results of achieving the specified goal, aspects that may be out of scope, and other implications and factors. FIG. 2J is an example portion of the machine learning model report that may display a comparison between the unmitigated versus mitigated bias metrics. The output may illustrate which approach was taken, at what stage, and may compare different potential approaches.

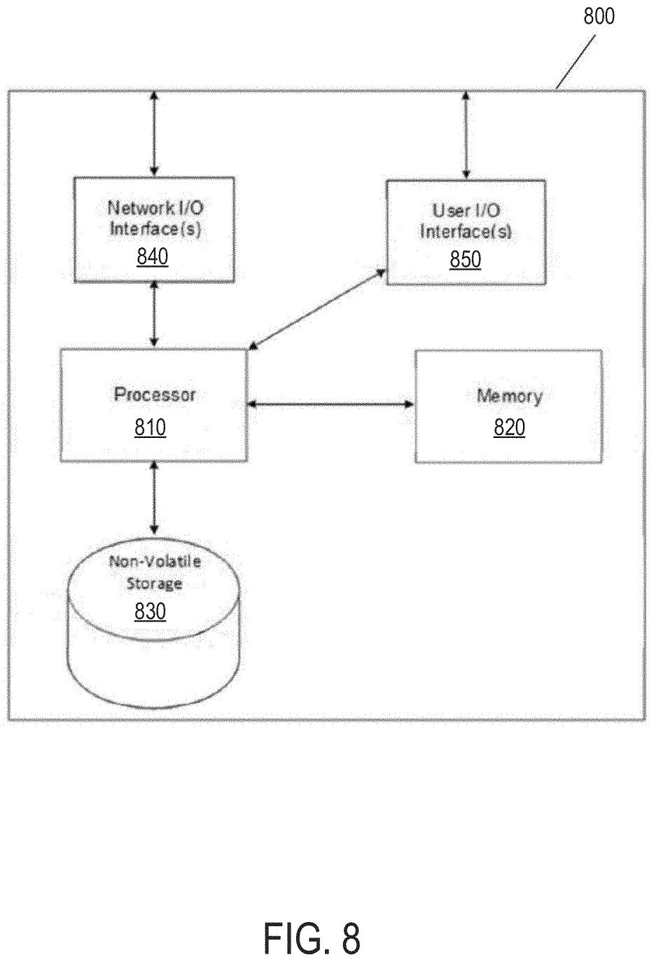

FIG. 3A is a flowchart of an illustrative process 300 for generating a risk report using NLP techniques and answers to risk questions for assessing risk in the machine learning model, in accordance with some embodiments of the technology described herein. Process 300 may be performed by any suitable computing device(s). For example, process 300 may be performed by a laptop computer, a desktop computer, one or more servers, in a cloud computing environment, computing device 800 as described herein with respect to FIG. 8, or in any other suitable way.

Process 300 begins at act 302 for obtaining natural language text including a plurality of answers to a respective plurality of questions for assessing risk for the machine learning model. As described herein with respect to FIGS. 1A-B, the plurality of questions for assessing risk may include an initial set of general risk questions, custom questions added by one or more users, and/or questions added from a searchable catalog of documents provided in a GUI. Answers to the questions for assessing risk may be obtained as natural language text via the provided GUI and/or any other suitable user interface (e.g., messaging platforms, e-mail, external webpages, etc.).

Once the natural language text has been obtained, process 300 may proceed to act 304 for determining, using a first NLP technique, whether the plurality of answers are complete. In some embodiments, act 304 may be executed based on a user(s) command (e.g., user submits the answers) to check one, some, or all of the answers. In other embodiments, act 304 may be executed in real-time, as a user enters each answer. In some embodiments, the first NLP technique may determine whether each individual answer is complete, whether some answers are complete, whether most answers are complete, and/or whether all answers are complete. In some embodiments, act 304 may be repeated more than one time before proceeding to act 306.

Act 306 may include identifying, using a second NLP technique and from among a plurality of topics, a set of one or more topics related to risk associated with the machine learning model. In some embodiments, the second NLP technique may use, as input, the natural language text obtained at act 302 and/or the output from the first NLP technique at act 304. In some embodiments, the plurality of topics may include topics generally related to risk, topics that may be relevant to the model, and/or other topics.

Process 300 may then proceed to act 308, where a risk report may be generated for the machine learning model using the identified set of topics. The risk report may indicate at least one risk associated with the machine learning model. In some embodiments, the risk report may be generated in part by accessing an external database listing risk(s) and/or action(s) related to the identified topics.

At act 310, the risk report may be output to a user of the software. In some embodiments, the risk report may be output to a provided GUI, sent via communication services, printed, or output in any other suitable way. In some embodiments, the risk report may be output to more than one user.

FIG. 3B is a flowchart illustrating an example implementation of act 304 of process 300 for determining whether an answer is complete, in accordance with some embodiments of the technology described herein.

Act 322 may include extracting a number of keywords from the first answer of the plurality of answers using the first NLP technique. In some embodiments, act 322 may include sub-acts 332 and 334. Sub-act 332 may include generating a graph representing the first answer, the graph including nodes representing words in the first answer and edges representing co-occurrence of words that appear within a threshold distance in the first answer. In some embodiments, the threshold distance may be within 1 word, within 2 words, within 4 words, within 8 words, or within 10 words. Following sub-act 332, sub-act 334 may include identifying the number of keywords by applying a ranking algorithm to the generated graph. In some embodiments, the ranking algorithm may determine a salience score for each node by evaluating a number of edges linked to it. From the salience scores, the ranking algorithm may identify keywords as the words represented by nodes with high scores (e.g., greater number of edges directed towards it) relative to the other nodes. R. Mihalcea and P. Tarau (“TextRank: Bringing Order into Texts,” in Proc. EMNLP, pp. 404-411, 2020) describe a graph-based ranking algorithm which may be applicable to any one of the methods described herein and is incorporated herein by reference in its entirety.

Once keywords have been extracted, the process may proceed to act 324 for determining whether the number of keywords exceeds a specified threshold. For example, the specified threshold may be at least 1, at least 2, at least 4, or at least 6 words. In some embodiments, the threshold number of keywords may depend on the length of the text.

In some embodiments, if the number of keywords exceeds the specified threshold at act 324, then the first answer may be determined to be complete. If the number of keywords does not exceed the specified threshold at act 324, then the first answer may be determined to be incomplete. In the case that the answer is determined to be incomplete, the user may edit the answers and submit them to the first and/or second NLP techniques. In the case that the answer is determined to be complete, the process may proceed to the second NLP technique at act 306.

FIG. 3C is a flowchart illustrating an example implementation of act 306 of process 300 for identifying the set of one or more topics related to risk associated with the machine learning model, in accordance with some embodiments of the technology described herein.

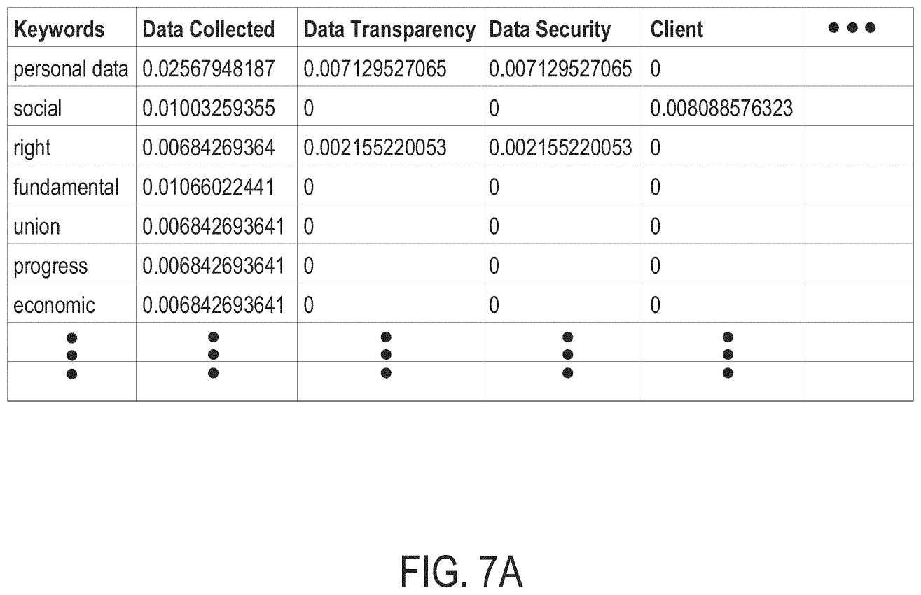

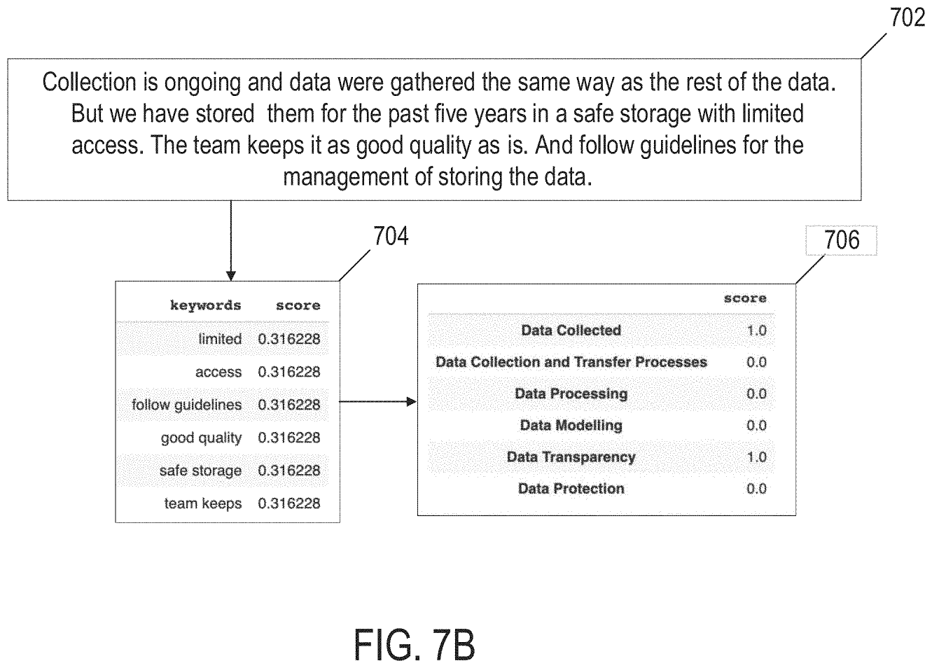

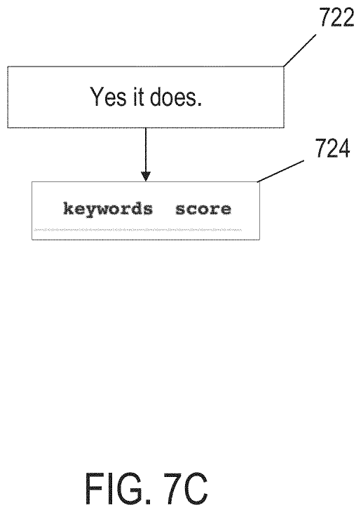

The process may begin at act 342 for embedding the plurality of answers into a latent space to obtain an embedding, the latent space including coordinates corresponding to the plurality of topics. In some embodiments, act 342 may include sub-acts 352, 354, and 356. Sub-act 352 may include generating a graph representing the plurality of answers. In some embodiments, the graph may be similar to the graph generated in sub-act 332 of FIG. 3B. The graph may include nodes representing words and edges representing co-occurrence of words that appear within a threshold distance in the plurality of answers. The plurality of answers may be considered together (e.g., as a single text), such that the graph includes all of the answers, and/or considered separately. The graph may then be used, at sub-act 354, to identify a plurality of keywords and their associated salience scores, as described with respect to FIG. 3B. At sub-act 356, a vector representing the plurality of keywords and their associated salience scores may be generated, further described herein with respect to FIGS. 7A-C.

Proceeding to act 344, a similarity score may be determined between the embeddings and the coordinates corresponding to the plurality of topics. In some embodiments, the similarity score may be determined by calculating cosine similarity, Jaccard similarity, Euclidean distance, or by calculating any other suitable similarity metric.

Once similarity scores have been determined, the process may proceed to act 346, which may include identifying the set of one or more topics based on the similarity scores. In some embodiments, the similarity scores may be normalized such that the values fall between zero and one. In some embodiments, if a similarity score exceeds a specified threshold, then the topic associated with the coordinates that resulted in that similarity score may be identified. For example, a topic associated with a similarity score that is greater than a random weight may identified as a topic related to risk for the machine learning model. In some embodiments, a topic associated with a normalized similarity score that is greater than, 1/12, ⅙, ¼, or ½ may be identified as a topic related to risk for the machine learning model.

As a result of process 300, a risk report may be generated and output. In some embodiments, the risk report may be output to a GUI, as described with respect to FIGS. 1B and 2F.

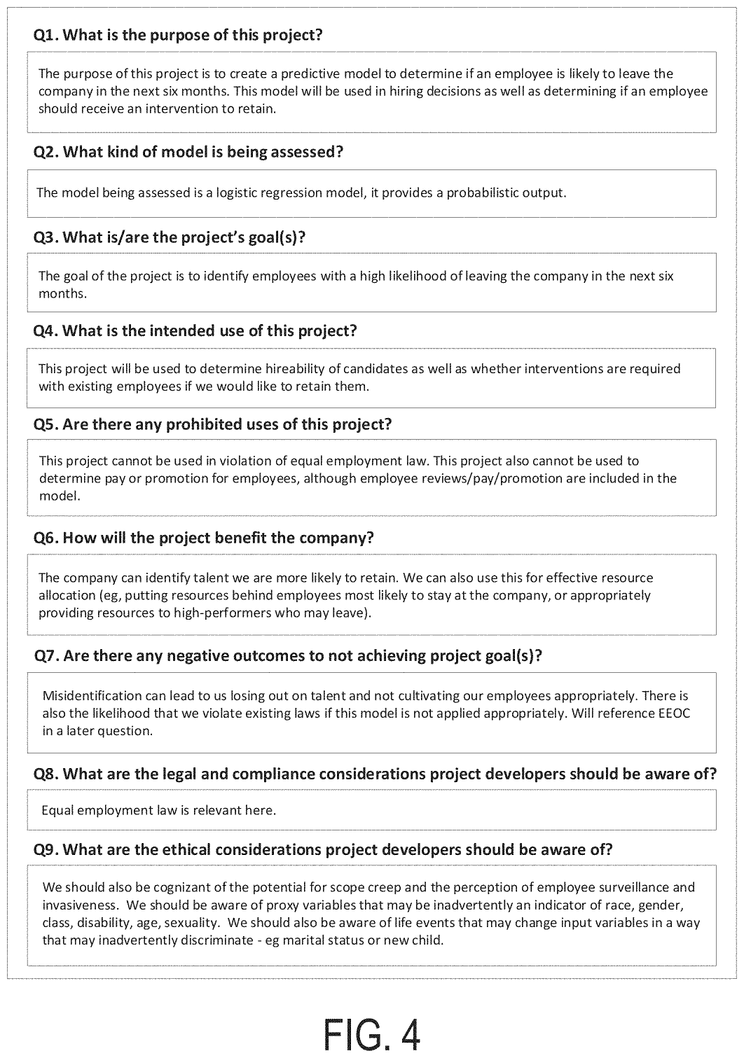

FIG. 4 is a list of example questions and answers for assessing risk. Some embodiments may include none of these questions, one of these questions, some of these questions, most of these questions, or all of these questions. In some embodiments, additional questions may be added, including custom questions and/or questions added from a searchable catalog of documents, as discussed with respect to FIGS. 1B and 2B-C. A non-limiting list of example questions associated with documents in an example searchable catalog are listed in Table 1.

The example questions included in FIG. 4 may capture different aspects of the machine learning model (e.g., type, goal, intended use, prohibited use, and business impact) and/or legal, compliance, and ethical considerations that may be relevant to a machine learning model and/or a business. In some embodiments, a single user or multiple users may answer these questions. For example, a hiring manager assessing a hiring machine learning model may answer questions related to intended outcomes of the model, while members of a risk management team may answer questions related to policy, regulations, and guidelines.

In some embodiments, questions may be assigned via different communication platforms to one or more users. For example, the questions may be assigned via e-mail, messaging platforms, and/or any other suitable communication platforms. Similarly, users who are assigned questions may respond via the communication platform or a provided GUI, as described with respect to FIGS. 1B and 2D-E. In some embodiments, the questions for assessing risk may be automatically populated with answers sent via the communication platform.

In some embodiments, the tools provided for answering the questions for assessing risk may help to improve upon conventional techniques for identifying risk associated with a machine learning model. The tools enable multiple users to collaboratively and remotely answer questions, each user providing different insights (e.g., insights into the data, machine learning model, legal issues, and business goals) into the project at hand. Further, the searchable catalog may prompt users to think about and incorporate other information that may help to uncover risks associated with aspects of the machine learning model that were nor previously considered.

As a result of incorporating these techniques, a machine learning model may be assessed from a global perspective, rather than the narrow perspective of conventional techniques. Additionally, the incorporation of features that enable users to remotely provide answers to questions may increase the efficiency of the risk assessment task.

TABLE 1
Example documents and associated questions.

| Document | | Publication | | | |
|---|---|---|---|---|---|
| Name | Producer | Year | Country | Topic | Question |
| AI: Australia's | Department of | 2019 | AUS | AI Ethics | Does the AI ensure |
| Ethics | Industry Innovation | | | | non-discrimination? |
| Framework | and Science | | | | |
| AI4Belgium | AI 4 Belgium | 2020 | BEL | AI Ethics | Is the AI designed |
| | Coalition | | | | with human centricity |
| | | | | | at its core? |
| Directive on | Government of | 2019 | CAN | Legislation | Has the organization |
| Automated | Canada | | | | established |
| Decision- | | | | | contingency systems? |
| Making | | | | | |
| Report of | COMEST/UNESCO | 2017 | Inter- | Robot | Has the maker |
| COMEST on | | | national | Ethics | assessed the potential |
| Robotics Ethics | | | | | environmental |
| | | | | | implications of the |
| | | | | | robot? |
| How to Prevent | World Economic | 2018 | Inter- | AI Ethics | Have we openly |
| Discriminatory | Forum | | national | | disclosed what aspects |
| Outcomes in | | | | | of the decision making |
| Machine | | | | | are algorithmic? |
| Learning | | | | | |

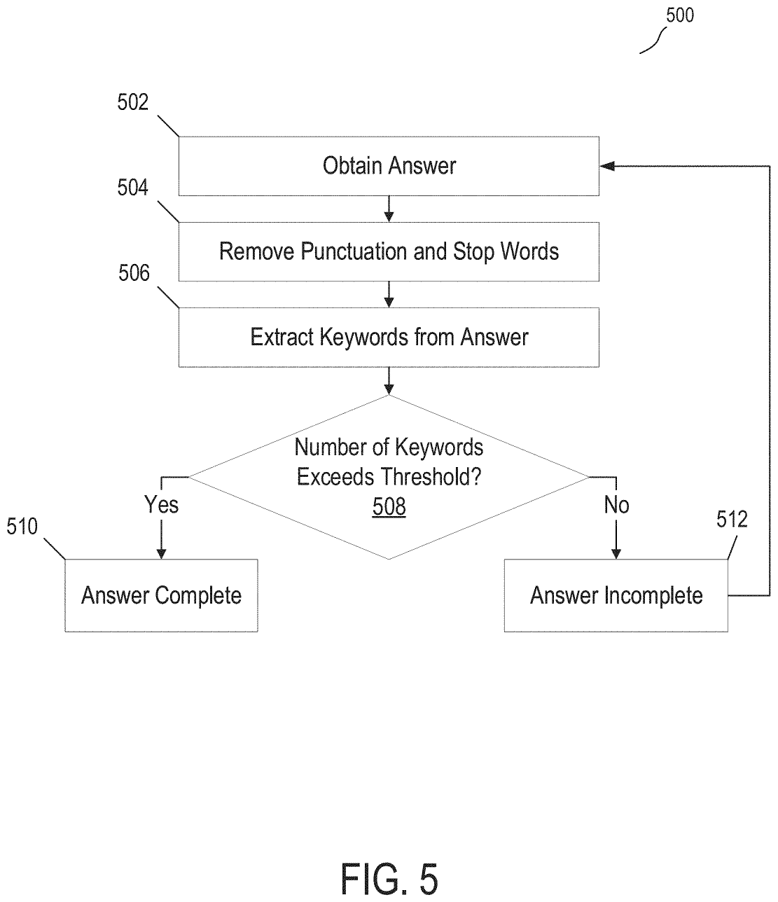

In some embodiments, as described with respect to FIG. 3B, once questions for assessing risk have been answered, the answers may be checked for completeness using the first NLP technique. FIG. 5 is an example flowchart of process 500 for determining whether an answer is complete, in accordance with some embodiments of the technology described herein.

Flowchart 500 may begin with act 502 for obtaining an answer. In some embodiments, the user may submit one or more answers by selecting an option through the GUI. In other embodiments, the answer may be obtained automatically as a user enters the answers.

Once the answer has been obtained, a pre-processing act 504 may include removing punctuation and stop words from the obtained answer. Stop words may include common words that are filtered out prior to processing natural language text data. In some embodiments, stop words may include prepositions, articles, conjunctions, and pronouns. Some non-limiting examples of stop words include: “least,” “until,” “by,” “all,” “anyways,” “others,” “then,” “be,” “than,” “though,” and “two.”

Flowchart 500 may then proceed to act 506 for extracting keywords from the processed answer. In some embodiments, the keywords may be extracted as described with respect to FIG. 3B. The number of keywords extracted may then be compared to a threshold at act 508. If the number of keywords exceeds the threshold, flowchart 500 may proceed to decision 510, indicating that the answer is complete. If the number of keywords does not exceed the threshold, flowchart 500 may proceed to decision 512, indicating that the answer is incomplete. In some embodiments, the threshold may be at least 1, at least 2, at least 4, or at least 6 words. In other embodiments, the threshold may depend on the total number of words in the answer.

In some embodiments, a decision 510, 512 may be reached for each answer. In some embodiments, if at least one of the answers is deemed to be incomplete at decision 512, then the user may have the opportunity to edit the answers, and flowchart may return to act 502. The GUI including the questions for assessing risk may indicate which of the answers were determined to be incomplete. In some embodiments, the users may edit and submit answers to the second NLP technique for identifying topics related to risk. In other embodiments, the users may not edit any of the answers, but submit the answers to the second NLP technique for identifying topics related to risk. In some embodiments, if none, one, some, most, or all of the answers are determined to be complete by the first NLP technique, then they may be automatically used as input to the second NLP technique for identifying topics related to risk.

In some embodiments, any other suitable technique may be used to perform a completeness check. In some embodiments, a completeness check may include using word and/or character count filters. In some embodiments, machine learning and/or deep learning techniques may be used to classify complete and incomplete answers. In some embodiments, transfer learning from pre-trained models may be used to classify complete and incomplete answers. In some embodiments, ZeroShot learning using a pre-trained language model may be used to classify complete and incomplete answers.

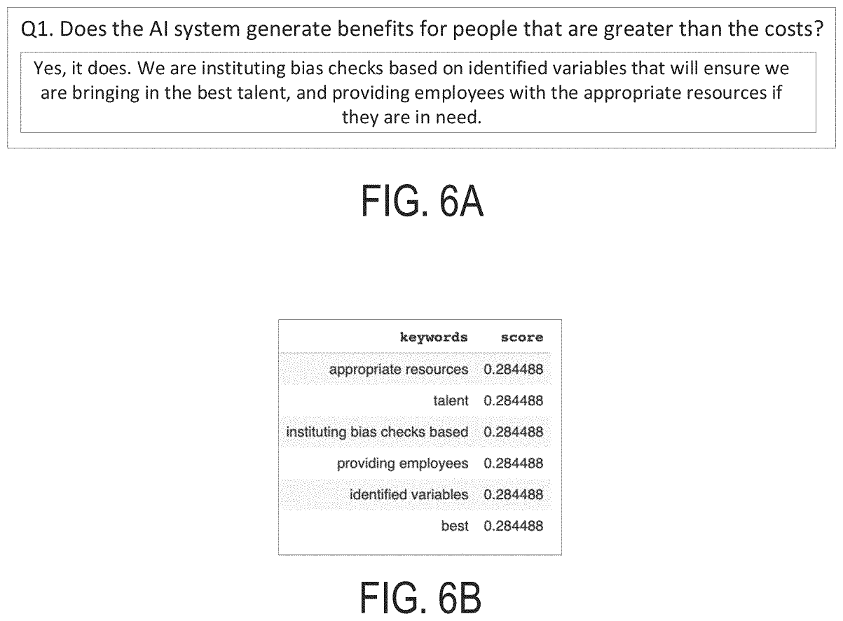

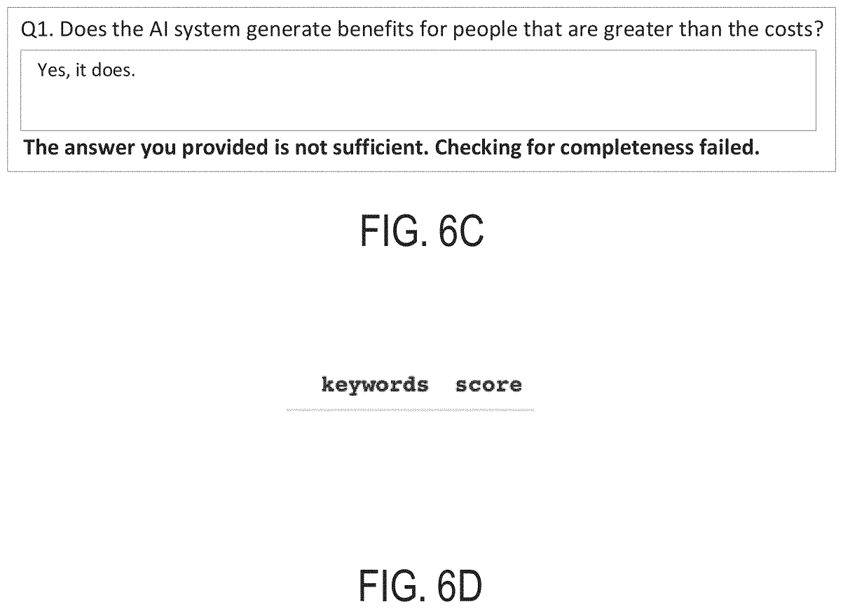

FIGS. 6A-D show examples of answers being checked for completeness using the second NLP method, as described above with respect to FIGS. 3B and 5.

FIG. 6A shows an example answer to the question for assessing risk. Once submitted to the first NLP technique for checking for completeness, punctuation and stop words may be removed. In this example, “it,” “does,” “we,” “are,” “on,” “that,” “will,” “in,” “the,” “and,” “with,” “if,” and “they” may be considered to be stop words. As a result of the pre-processing stage, the text “yes instituting bias checks based identified variables ensure bringing best talent providing employees appropriate resources need” may be used as input to the next act. Keywords may then be extracted from the processed answer. FIG. 6B shows a list of keywords extracted from the answer provided in FIG. 6A, along with their associated salience scores. In some embodiments, only keywords with a salience score above a specified threshold may be extracted. Once extracted, the number of keywords may be compared to a threshold (e.g., 2 keywords). Since the number of keywords extracted from the example answer exceeds an example threshold of 2 keywords, the example answer is determined to be complete. As a result, no feedback may be provided to the user and the text may be input to the second NLP technique for identifying one or more topics related to risk associated with the machine learning model.

FIG. 6C shows another example answer to the question for assessing risk. Once submitted to the first NLP technique for checking for completeness, punctuation and stop words may be removed. In this example, “it” and “does” may be considered stop words. As a result of the pre-processing stage, text “yes” may be used as input to the next act. Keywords may then be extracted from the processed answer. As shown in FIG. 6D, the keyword extraction for this example answer does not yield any keywords. As a result, feedback may be output to the user, as shown in FIG. 6C, indicating that the answer is not complete.

The first NLP technique for checking for completeness may help to ensure that the answers provide enough information for a complete and accurate assessment of risk. This further improves upon conventional techniques, which may not include such checks for completeness. As a result, conventional techniques may miss valuable information that could help provide a thorough assessment.

In some embodiments, answers may be checked for completeness using the first NLP technique prior to being input to the second NLP technique for identifying one or more topics related to risk associated with the machine learning model. In some embodiments, keywords that are extracted using the first NLP technique may be used by the second NLP technique to generate the vector representing keywords and their associated salience scores, as described with respect to FIG. 3C. In other embodiments, answers may be processed and keywords may be extracted, as described with respect to FIG. 5, as part of the second NLP technique.

In each of these embodiments, an embedding may be obtained by embedding the answers into a latent space that includes coordinates corresponding to the plurality of topics, as described with respect to FIG. 3C.

FIG. 7A shows example coordinates corresponding to four example topics (e.g., Data Collected, Data Transparency, Data Security, and Client). The coordinates corresponding to each of the topics include keywords, as listed in the leftmost column, and salience scores corresponding to each keyword, listed below the label for each topic.

In some embodiments, keywords may be obtained from one or more documents related to the topics. As part of this process, a topic may be identified for a document based on the natural language text contained within each document. This may be done manually, by NLP techniques, and/or by any other suitable technique. Once a topic is identified for the document, a graph-based approach, similar to the graph-based approach described with respect to FIGS. 3B-C, may be used to extract keywords and associated salience scores from each document. In some embodiments, the graph-based approach includes representing the document as a graph including vertices that represent the sentences and edges that represent similarity between sentences. A ranking algorithm, similar to that described with respect to sub-act 334 of FIG. 3B, may be used to identify key sentences in the document. In some embodiments, a threshold number of sentences may be extracted. For example, 5, 10, 25, 50, 100, or 200 sentences may be extracted. In other embodiments, the threshold number of sentences may be based on the total number of sentences included in the document. For example, ¼, ½, or ¾ of the total number of sentences may be extracted. Once the top sentences have been identified, keywords may be extracted from the top sentences using the keyword extraction techniques described with respect to FIGS. 3B-C. In some embodiments, the keywords and associated salience scores may be included in the coordinates corresponding to the topic identified for the document. In some embodiments, at least 100, at least 1,000, at least 10,000, at least 100,00, or at least 1 million documents may be processed using these techniques. In some embodiments, the coordinates corresponding to each topic may include at least 100, at least 1,000, at least 10,000, at least 100,000, at least 1 million, at least 10 million, or at least 100 million keywords and associated salience scores.

In some embodiments, the coordinates for each topic may include all keywords extracted for all documents, along with the associated salience scores. Keywords that are not extracted for a topic (e.g., “social” for the Data Transparency topic) may be represented by a salience score of 0.

In some embodiments, topics may be generally related to risk (e.g., Data Processing, Data Transparency, etc.) and/or specific to certain industries (e.g., Financial Markets, Agriculture Credit, etc.). Depending on the machine learning model that is being assessed, some topics may be included in the latent space, while others are not. For example, general risk topics and an agriculture credit topic may be included for assessing a machine learning model being used for predictive analysis for a farm. However, the agriculture credit topic may not be applicable for assessing risk of a machine learning model being used by a pharmaceutical company.

FIGS. 7B-C show examples of results that may be obtained using the second NLP technique to identify topics related to risk, based on example answers to the questions associated with risk.

FIG. 7B shows an example answer 702 input to the second NLP technique. In some embodiments, answer 702 may be processed, as described with respect to FIG. 5, to remove stop words and punctuation. A graph-based approach and ranking algorithm may be used to identify keywords 704 and their salience scores from the processed text. The keywords 704 and salience scores may be used to generate a vector. The vector may include all keywords included in the coordinates corresponding to each topic. Keywords that are not extracted from the answer 702 may be represented within the vector as having a salience score of 0. Once the vector has been generated, similarity scores may be computed between the generated vector and the coordinates for each topic. In some embodiments, the similarity scores may be normalized. High similarity scores may be used to identify topics that are related to the text input. In some embodiments, topics that yield similarity scores over a specified threshold may be output as the identified topics related to risk. In some embodiments, if the similarity score is above a random weight, the topic may be identified as a topic related to risk. For example, if a normalized similarity score exceeds 1/16, ⅛, ¼, or ½, it may be identified as a topic related to risk.

For the example shown in FIG. 7B, similarity scores 706 are computed between the vector generated from keywords 704 and the coordinates related to six topics. The resulting similarity scores 706, based on the extracted keywords 704 and coordinates corresponding to the plurality of topics, indicate that the answer 702 is most related to the Data Transparency and Data Collected topics, with similarity scores of 1.0. In some embodiments, the Data Transparency and Data Collected topics would be output to a risk report since the normalized similarity scores of 1.0 exceeds an example threshold of ⅛.

FIG. 7C shows an example answer 722 input to the second NLP technique. In some embodiments, answer 722 may be processed, as described with respect to FIG. 5, to remove stop words and punctuation. A graph-based approach and ranking algorithm may be used to identify keywords 724 and their salience scores from the processed text. As shown, no keywords 704 were extracted from answer 722. As a result, no topics may be identified for the answer 722. In some embodiments, had this answer been checked for completeness using the first NLP technique, feedback would indicate to the user that this answer is incomplete (e.g., cannot be assessed for risk).

In some embodiments, similarity scores may be compared to a specified threshold. If the similarity score exceeds the threshold, the topic associated with the coordinates used for calculating the similarity score may be identified as a topic related to risk associated with the machine learning model. If the similarity score does not exceed that threshold, then the topic associated with the coordinates may not be identified. In some embodiments, topics with similarity scores that are below the specified threshold, but are non-zero, may be output to one or more users. This may help users to identify other patterns associated with the model.

In some embodiments, keywords that are identified using the graph-based approach and ranking algorithm may not be included in the coordinates corresponding to the plurality of topics in a specifically trained topic model. However, some embodiments may include deep learning techniques for identifying topics related to risk even in the case where the keywords are not included in the coordinates corresponding to the topics. The technique may use a pre-trained language model to perform natural language inference (e.g., determining whether a hypothesis is true, false, or undetermined) to determine a set of probabilities for each topic. Natural language inference may allow the pre-trained language model to fine-tune on a specific set of keywords and/or sentences using sequence-to-sequence modelling. In some embodiments, answers to questions for assessing risk may be input to the pre-trained language model and identify topics related to risk associated with the machine learning model. An example pre-trained language model is described by Lewis et al. (“BART: Denoising Sequence-to-Sequence Pre-training for Natural Language Generation, Translation, and Comprehension,” in Proc. ACL, pp. 7871-7880, 2020), which is incorporated herein by reference in its entirety.

As described with respect to FIGS. 1A-B and 2F, a risk report may be generated using the set of topics identified using the second NLP technique. The risk report may include the identified topics, as well as actions of measuring and mitigating bias. In some embodiments, the actions may include both technical and non-technical actions. Examples of non-technical actions are listed in Table 2, while examples of technical actions are listed in Table 3.

Table 3 includes non-limiting examples of fairness metrics, fairness mitigations, and explainability tools. The listed fairness metrics are described by Bellamy et al. (“AI Fairness 360: An Extensible Toolkit for Detecting, Understanding, and Mitigating Unwanted Algorithmic Bias,” in IBM Journal of Research and Development, vol. 63, no. 4/5, pp. 4:1-4:15, 2019), which is incorporated herein by reference in its entirety.

The listed fairness mitigations include Disparate Impact Remover, Learning Fair Representation, Reweighing, Prejudice Remover, and Calibrated Equality of Odds. Details of the Disparate Impact Remover are described by Feldman et al. (“Certifying and Removing Disparate Impact,” in Proc. ACM SIGKDD, pp. 259-269, 2015), which is incorporated herein by reference in its entirety. Details of Learning Fair Representation are described by Zemel et al. (“Learning Fair Representations,” in Proc. MLR, 28(3):325-333, 2013), which is incorporated herein by reference in its entirety. Details of Reweighing are described by Kamiran and Calders (“Data preprocessing techniques for classification without discrimination,” in Knowl Inf Syst, 33:1-33, 2012), which is incorporated herein by reference in its entirety. Details of the Prejudice Remover are described by Kamishima et al. (“Fairness-Aware Classifier with Prejudice Remover Regularizer,” in Proc. ECML PPKD, Part II., pp. 35-50, 2012), which is incorporated herein by reference in its entirety. Details of Calibrated Equality of Odds are described by Pleiss et al. (“On Fairness and Calibration,” in Proc. NIPS, 30, 2017), which is incorporated herein by reference in its entirety.

The listed explainability tools include Shapley Functions (SHAP) and counterfactuals. Details of SHAP are described by Lundberg and Lee (“A Unified Approach to Interpreting Model Predictions,” in Proc. NIPS, pp. 4768-4777, 2017), which is incorporated herein by reference in its entirety. Details of counterfactuals are described by Wachter et al. (“Counterfactual Explanations Without Opening the Black Box: Automated Decisions and the GDPR,” in Harvard Journal of Law & Technology, vol. 31, no. 2, pp. 841-887), which is incorporated herein by reference in its entirety.

TABLE 2
Example non-technical actions for mitigating bias.

| Topic | Description | Subtasks |
|---|---|---|
| Data | Describes quality and sensitivity | Identify and track Inventorying and |
| Collected | of the features being included in | Assessing Personally Identifiable |
| | the AI system, such as concerning | Information (PII), or Sensitive |
| | whether groups are disproportion- | Personal Information (SPI). |
| | ately represented in the | Account for institutional or |
| | data. | historical bias. |
| | | Review sources of bias in big data |
| | | from mobile phones, social media, |
| | | and travel observation, and |
| | | describes aggregation bias, |
| | | coverage bias, non-response bias, |
| | | sampling (or demographic) bias, |
| | | selection bias, and social |
| | | desirability bias through examples |
| | | from research and interviews. |
| | | Review information collected if |
| | | skewed/biased, sampling bias, |
| | | selection bias, resource bias, etc. |
| Data Collection | Intended to define the scope and | Review Data Collection Procedure |
| and Transfer | flow of information sharing, | if it covered justifiable/legal cause |
| Processes | receiving and transmitting. | of obtaining the data. |
| | | Review Transfer Processes if it |
| | | covers data sanitation request and |
| | | handling data destruction |
| | | Review Data Request Procedure if |
| | | it covers all necessary information |
| | | needed for your specific use case |
| | | (e.g., timeline of data validity, |
| | | volume of data to be collected, etc.) |
| | | Proactively do bias aware data |
| | | collection. |
| | | Review if collection is with consent |
| | | and justified. |
| Data Processing | Directs possible risk at which the | Remove PII or scrub data. |
| | transformation and the accuracy | Verify if all data processing |
| | of the data being collected. | tools/services compliant with |
| | | company rules |
| | | Review justifications of all the data |
| | | processing activities |
| | | Proactively do bias aware data |
| | | processing |
| Data Modelling | Covers the capabilities of the | Review model's vulnerabilities. |
| | model and its quality in terms of | Verify data accuracy used in the |
| | explainability and fairness. | model. |
| | | Document all data modelling |
| | | activities throughout the model |
| | | cycle such as fine tuning and |
| | | iteration procedures. |
| | | Keep an accessible dashboard for |
| | | easy view of status and |
| | | performance of the models |
| | | Document workflow process of the |
| | | approval and model management |
| | | across departments and systems. |
| Data | Intends to describe how information | Secure that users are aware and |
| Transparency | are comprehensive, appropriate and | understands information on the |
| | easily accessible to data subjects or | purpose of all data processing and |
| | involved users. | the data being collected, potential |
| | | controllers and who has access of |
| | | the data, and the period during |
| | | which the collected data will be |
| | | stored. |
| | | Review plan and procedure |
| | | informing users affected once |
| | | there's a data breach. Must have |
| | | transparency into the details of the |
| | | incident. |
| Data Protection | Intended to describe show security | Review established Data Protection |
| | measures are governed and con- | Policies and Procedures |
| | ducted to maintain quality of the | (administrative, technical and |
| | data and to defend possible | physical security safeguards to |
| | external or internal breach. | ensure confidentiality, integrity and |
| | | availability of data) |
| | | Review company internal controls |
| | | and access protocols. The |
| | | organization should have the ability |
| | | to detect, prevent and track |
| | | unauthorized or inappropriate |
| | | access to data |
| | | Review data sharing controls and |
| | | policies. Information security must |
| | | constantly be assessed, monitored, |
| | | and updated to meet new threats |
| | | Review if the organization can |
| | | provide Proof of Compliance |
| | | Review Response Strategy and |
| | | Plan |

TABLE 3
Example technical actions for mitigating bias.

| Type | Tool | Description |
|---|---|---|
| Fairness | Statistical Parity | Difference in the probability of favorable |
| Metrics | Difference | outcomes between the unprivileged and |
| | | privileged groups. |
| | Equal Opportunity | Difference in true positive rates between |
| | Difference | unprivileged and privileged groups. |
| | Average Absolute | Average difference in false positive rates |
| | Odds Difference | and true positive rates between |
| | | unprivileged and privileged groups. |
| | Disparate Impact | Ratio between the probability of |
| | | favorable outcomes between privileged |
| | | and unprivileged groups. |
| | Theil Index | Statistic used to measure economic |
| | | inequality. |
| Fairness | Disparate Impact | Mask bias and preserve relevant |
| Mitigations | Remover | information in the data. |
| | Learning Fair | Achieve both group and individual |
| | Representation | fairness. |
| | Reweighing | Algorithmic solution to preprocess the |
| | | data to remove discrimination before |
| | | classifier is learned. |
| | Prejudice Remover | Regularization approach to eliminate |
| | | bias. |
| | Calibrated Equality | Minimizing error disparity across |
| | of Odds | different population groups while |
| | | maintaining calibrated probability |
| | | estimates. |
| Explain- | SHAP | Game theoretic approach to explain the |
| ability | | output of any machine learning model. |
| | Counterfactuals | Rationale for why something is classified |
| | | as not within the given class. |

An illustrative implementation of a computer system 800 that may be used in connection with any of the embodiments of the technology described herein (e.g., such as the method of FIGS. 3A-C) is shown in FIG. 8. The computer system 800 includes one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner, as the aspects of the technology described herein are not limited in this respect. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

Computing device 800 may also include a network input/output (I/O) interface 840 via which the computing device may communicate with other computing devices (e.g., over a network), and may also include one or more user I/O interfaces 850, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

The foregoing description of implementations provides illustration and description but is not intended to be exhaustive or to limit the implementations to the precise form disclosed. Modifications and variations are possible in light of the above teachings or may be acquired from practice of the implementations. In other implementations the methods depicted in these figures may include fewer operations, different operations, differently ordered operations, and/or additional operations. Further, non-dependent blocks may be performed in parallel. It will be apparent that example aspects, as described above, may be implemented in many different forms of software, firmware, and hardware in the implementations illustrated in the figures. Further, certain portions of the implementations may be implemented as a “module” that performs one or more functions. This module may include hardware, such as a processor, an application-specific integrated circuit (ASIC), or a field-programmable gate array (FPGA), or a combination of hardware and software.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, a tablet, or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately,” “substantially,” and “about” may be used to mean within ±20% of a target value in some embodiments, within ±10% of a target value in some embodiments, within ±5% of a target value in some embodiments, within ±2% of a target value in some embodiments. The terms “approximately,” “substantially,” and “about” may include the target value.

What is claimed is:

1. A method for assessing risk associated with a machine learning model trained to perform a task, the method comprising:
using at least one computer hardware processor to execute software to perform:
obtaining natural language text comprising a plurality of answers to a respective plurality of questions for assessing risk for the machine learning model;
identifying, using a second natural language processing (NLP) technique and from among a plurality of topics, a set of one or more topics related to risk associated with the machine learning model;
generating a risk report for the machine learning model using the identified set of topics, the risk report indicating at least one risk associated with the machine learning model and at least one action to perform for mitigating the at least one risk associated with the machine learning model; and
outputting the risk report to a user of the software.

2. The method of claim 1, further comprising, after obtaining the natural language text, determining, using a first NLP technique, whether the plurality of answers are complete.

3. The method of claim 1, wherein obtaining the natural language text comprises:
determining the plurality of questions based on input from a first user of the software; and
sending a notification to a second user of the software to answer at least some of the plurality of questions.

4. The method of claim 3, wherein determining the plurality of questions comprises:
identifying an initial set of questions;
receiving input from the first user, the input being indicative of at least one question selected by the first user from a library of additional questions; and
updating the initial set of questions to include the at least one question.

5. The method of claim 4, wherein the method further comprises:
presenting, to the first user, a graphical user interface providing access to a searchable catalog of artificial intelligence policy documents, at least some of the artificial intelligence policy documents being associated with respective questions for assessing risk of a machine learning model; and
receiving the input being indicative of the at least one question through the graphical user interface.

6. The method of claim 2, wherein the plurality of answers comprises a first answer to a first question in the plurality of questions, and wherein determining whether the plurality of answers are complete comprises determining whether the first answer is complete at least in part by:
extracting a number of keywords from the first answer using the first NLP technique; and
determining whether the number of keywords exceeds a specified threshold.

7. The method of claim 6, wherein extracting the number of keywords from the first answer using the first NLP technique comprises extracting the number of keywords using a graph-based keyword extraction technique.

8. The method of claim 7, wherein extracting the number of keywords from the first answer comprises:
generating a graph representing the first answer, the graph comprising nodes representing words in the first answer and edges representing co-occurrence of words that appear within a threshold distance in the first answer; and
identifying the number of keywords by applying a ranking algorithm to the generated graph.

9. The method of claim 6, wherein determining whether the plurality of answers are complete comprises determining whether at least a preponderance of the plurality of answers is complete by using the first natural language processing technique.

10. The method of claim 9, wherein determining whether the plurality of answers are complete comprises determining whether each of the plurality of answers is complete by using the first NLP technique.

11. The method of claim 1, wherein identifying the set of one or more topics related to risk associated with the machine learning model comprises:
embedding the plurality of answers into a latent space to obtain an embedding, the latent space comprising coordinates corresponding to the plurality of topics;
determining similarity scores between the embedding and the coordinates corresponding to the plurality of topics; and
identifying the set of one or more topics based on the similarity scores.

12. The method of claim 11, wherein embedding the plurality of answers into the latent space comprises:
generating a graph representing the plurality of answers;
identifying, using the graph, a plurality of keywords and associated saliency scores; and
generating a vector representing the plurality of keywords and their associated saliency scores.

13. The method of claim 1, wherein the at least one action to mitigate the risk comprises a first action to be performed on at least one data set used to train the machine learning model.

14. The method of 13, further comprising:
accessing the at least one data set; and
performing the first action on the at least one data set.

15. The method of claim 14, wherein performing the first action comprises processing the at least one data set to determine at least one bias metric, performing at least one bias mitigation, and/or executing one or more model performance explainability tools.

16. The method of claim 15, wherein performing the first action comprises processing the at least one data set to determine at least one bias metric, the at least one bias metric comprising a statistical parity difference metric, an equal opportunity difference metric, an average absolute odds difference metric, a disparate impact metric, and/or a Theil index metric.

17. The method of claim 15, wherein performing the first action comprises modifying the at least one dataset to obtain at least one modified data set and re-training the machine learning model using the at least one modified data set.

18. The method of claim 14, further comprising:
generating a machine learning model report, the machine learning model report comprising information indicating one or more actions, including the first action, taken to mitigate the at least one risk identified in the risk report; and
outputting the machine learning model report to the user of the software.

19. A system comprising:
at least one computer hardware processor; and
at least one non-transitory computer-readable storage medium storing processor executable instructions that, when executed by the at least one computer hardware processor, cause the at least one computer hardware processor to perform:
obtaining natural language text comprising a plurality of answers to a respective plurality of questions for assessing risk for the machine learning model;
identifying, using a second natural language processing (NLP) technique and from among a plurality of topics, a set of one or more topics related to risk associated with the machine learning model;
generating a risk report for the machine learning model using the identified set of topics, the risk report indicating at least one risk associated with the machine learning model and at least one action to perform for mitigating the at least one risk associated with the machine learning model; and
outputting the risk report to a user of the software.

20. At least one non-transitory computer-readable storage medium storing processor executable instructions that, when executed by at least one computer hardware processor, cause the at least one computer hardware processor to perform:
obtaining natural language text comprising a plurality of answers to a respective plurality of questions for assessing risk for the machine learning model;
identifying, using a second natural language processing (NLP) technique and from among a plurality of topics, a set of one or more topics related to risk associated with the machine learning model;
generating a risk report for the machine learning model using the identified set of topics, the risk report indicating at least one risk associated with the machine learning model and at least one action to perform for mitigating the at least one risk associated with the machine learning model; and
outputting the risk report to a user of the software.
